(19) United States
(12) Patent Application Publication
(10) Pub. No.: US 2009/0122113 A1
(43) Pub. Date: May 14, 2009

(54) Printhead Having Nozzle Arrangements With Radial Actuators

(75) Inventors: Kia Silverbrook, Balmain (AU); Gregory John McAvoy, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 12/277,295

(22) Filed: Nov. 24, 2008

Related U.S. Application Data
(63) Continuation of application No. 12/025,605, filed on Feb. 4, 2008, now Pat. No. 7,465,029.
Application No. 12/025,605 is a continuation of application No. 11/655,987, filed on Jan. 22, 2007, now Pat. No. 7,347,536.
Application No. 11/655,987 is a continuation of application No. 11/084,752, filed on Mar. 21, 2005, now Pat. No. 7,192,120.
Application No. 11/084,752 is a continuation of application No. 10/636,255, filed on Aug. 8, 2003, now Pat. No. 6,959,981.
Application No. 10/636,255 is a continuation of application No. 09/854,703, filed on May 14, 2001, now Pat. No. 6,981,757.
Application No. 09/854,703 is a continuation of application No. 09/112,806, filed on Jul. 10, 1998, now Pat. No. 6,247,790.

(30) Foreign Application Priority Data
Jun. 9, 1998 (AU) PP3987

(51) Int. Cl. B41J 2/14

(52) U.S. Cl. 347/48

(57) ABSTRACT

A printhead for an inkjet printer has a wafer that defines a plurality of nozzle chambers and ink supply channels in fluid communication with the nozzle chambers to supply the nozzle chambers with ink. An ink ejection port is associated with each nozzle chamber. A series of actuators is associated with each nozzle chamber and is radially positioned with respect to the nozzle chamber. The actuators are operable so that, when activated, they are displaced into the nozzle chamber to generate an ink meniscus at the ink ejection port and, when deactivated, return to an original position resulting in the necking and breaking of the ink meniscus to eject an ink drop.

### CROSS REFERENCES TO RELATED APPLICATIONS

The present application is a Continuation Application of U.S. patent application Ser. No. 12/025,605 filed on Feb. 4, 2008, which is a Continuation of U.S. application Ser. No. 11/655,987 filed Jan. 22, 2007, now issued U.S. Pat. No. 7,347,536, which is a Continuation of U.S. application Ser. No. 11/084,752 filed Mar. 21, 2005, now issued U.S. Pat. No. 7,192,120, which is a Continuation of U.S. application Ser. No. 10/636,255 filed Aug. 8, 2003, now issued U.S. Pat. No. 6,959,981, which is a continuation of Ser. No. 09/854,703 filed May 14, 2001, now issued U.S. Pat. No. 6,981,757, which is a Continuation of U.S. application Ser. No. 09/112,806 filed Jul. 10, 1998, now issued as U.S. Pat. No. 6,247,790, all of which are herein incorporated by reference.

The following Australian provisional patent applications are hereby incorporated by cross-reference. For the purposes of location and identification, US patent applications identified by their US patent application serial numbers (USSN) are listed alongside the Australian applications from which the US patent applications claim the right of priority.

| CROSS- | | |
|---|---|---|
| REFERENCED | US PATENT/PATENT | |
| AUSTRALIAN | APPLICATION (CLAIMING | |
| PROVISIONAL | RIGHT OF PRIORITY | |
| PATENT | FROM AUSTRALIAN | DOCKET |
| APPLICATION NO. | PROVISIONAL APPLICATION) | NO. |
| PO7991 | 6,750,901 | ART01US |
| PO8505 | 6,476,863 | ART02US |
| PO7988 | 6,788,336 | ART03US |
| PO9395 | 6,322,181 | ART04US |
| PO8017 | 6,597,817 | ART06US |
| PO8014 | 6,227,648 | ART07US |
| PO8025 | 6,727,948 | ART08US |
| PO8032 | 6,690,419 | ART09US |
| PO7999 | 6,727,951 | ART10US |
| PO8030 | 6,196,541 | ART13US |
| PO7997 | 6,195,150 | ART15US |
| PO7979 | 6,362,868 | ART16US |
| PO7978 | 6,831,681 | ART18US |
| PO7982 | 6,431,669 | ART19US |
| PO7989 | 6,362,869 | ART20US |
| PO8019 | 6,472,052 | ART21US |
| PO7980 | 6,356,715 | ART22US |
| PO8018 | 6,894,694 | ART24US |
| PO7938 | 6,636,216 | ART25US |
| PO8016 | 6,366,693 | ART26US |
| PO8024 | 6,329,990 | ART27US |
| PO7939 | 6,459,495 | ART29US |
| PO8501 | 6,137,500 | ART30US |
| PO8500 | 6,690,416 | ART31US |
| PO7987 | 7,050,143 | ART32US |
| PO8022 | 6,398,328 | ART33US |
| PO8497 | 7,110,024 | ART34US |
| PO8020 | 6,431,704 | ART38US |
| PO8504 | 6,879,341 | ART42US |
| PO8000 | 6,415,054 | ART43US |
| PO7934 | 6,665,454 | ART45US |
| PO7990 | 6,542,645 | ART46US |
| PO8499 | 6,486,886 | ART47US |
| PO8502 | 6,381,361 | ART48US |
| PO7981 | 6,317,192 | ART50US |
| PO7986 | 6,850,274 | ART51US |
| PO7983 | 09/113,054 | ART52US |
| PO8026 | 6,646,757 | ART53US |
| PO8028 | 6,624,848 | ART56US |
| PO9394 | 6,357,135 | ART57US |
| PO9397 | 6,271,931 | ART59US |
| PO9398 | 6,353,772 | ART60US |
| PO9399 | 6,106,147 | ART61US |
| PO9400 | 6,665,008 | ART62US |
| PO9401 | 6,304,291 | ART63US |
| PO9403 | 6,305,770 | ART65US |
| PO9405 | 6,289,262 | ART66US |
| PP0959 | 6,315,200 | ART68US |
| PP1397 | 6,217,165 | ART69US |
| PP2370 | 6,786,420 | DOT01US |
| PO8003 | 6,350,023 | Fluid01US |
| PO8005 | 6,318,849 | Fluid02US |
| PO8066 | 6,227,652 | IJ01US |
| PO8072 | 6,213,588 | IJ02US |
| PO8040 | 6,213,589 | IJ03US |
| PO8071 | 6,231,163 | IJ04US |
| PO8047 | 6,247,795 | IJ05US |
| PO8035 | 6,394,581 | IJ06US |
| PO8044 | 6,244,691 | IJ07US |
| PO8063 | 6,257,704 | IJ08US |
| PO8057 | 6,416,168 | IJ09US |
| PO8056 | 6,220,694 | IJ10US |
| PO8069 | 6,257,705 | IJ11US |
| PO8049 | 6,247,794 | IJ12US |
| PO8036 | 6,234,610 | IJ13US |
| PO8048 | 6,247,793 | IJ14US |
| PO8070 | 6,264,306 | IJ15US |
| PO8067 | 6,241,342 | IJ16US |
| PO8001 | 6,247,792 | IJ17US |
| PO8038 | 6,264,307 | IJ18US |
| PO8033 | 6,254,220 | IJ19US |
| PO8002 | 6,234,611 | IJ20US |
| PO8068 | 6,302,528 | IJ21US |
| PO8062 | 6,283,582 | IJ22US |
| PO8034 | 6,239,821 | IJ23US |
| PO8039 | 6,338,547 | IJ24US |
| PO8041 | 6,247,796 | IJ25US |
| PO8004 | 6,557,977 | IJ26US |
| PO8037 | 6,390,603 | IJ27US |
| PO8043 | 6,362,843 | IJ28US |
| PO8042 | 6,293,653 | IJ29US |
| PO8064 | 6,312,107 | IJ30US |
| PO9389 | 6,227,653 | IJ31US |
| PO9391 | 6,234,609 | IJ32US |
| PP0888 | 6,238,040 | IJ33US |
| PP0891 | 6,188,415 | IJ34US |
| PP0890 | 6,227,654 | IJ35US |
| PP0873 | 6,209,989 | IJ36US |
| PP0993 | 6,247,791 | IJ37US |
| PP0890 | 6,336,710 | IJ38US |
| PP1398 | 6,217,153 | IJ39US |
| PP2592 | 6,416,167 | IJ40US |
| PP2593 | 6,243,113 | IJ41US |
| PP3991 | 6,283,581 | IJ42US |
| PP3987 | 6,247,790 | IJ43US |
| PP3985 | 6,260,953 | IJ44US |
| PP3983 | 6,267,469 | IJ45US |
| PO7935 | 6,224,780 | IJM01US |
| PO7936 | 6,235,212 | IJM02US |
| PO7937 | 6,280,643 | IJM03US |
| PO8061 | 6,284,147 | IJM04US |
| PO8054 | 6,214,244 | IJM05US |
| PO8065 | 6,071,750 | IJM06US |
| PO8055 | 6,267,905 | IJM07US |
| PO8053 | 6,251,298 | IJM08US |
| PO8078 | 6,258,285 | IJM09US |
| PO7933 | 6,225,138 | IJM10US |
| PO7950 | 6,241,904 | IJM11US |
| PO7949 | 6,299,786 | IJM12US |
| PO8060 | 6,866,789 | IJM13US |
| PO8059 | 6,231,773 | IJM14US |
| PO8073 | 6,190,931 | IJM15US |
| PO8076 | 6,248,249 | IJM16US |
| PO8075 | 6,290,862 | IJM17US |
| PO8079 | 6,241,906 | IJM18US |
| PO8050 | 6,565,762 | IJM19US |
| PO8052 | 6,241,905 | IJM20US |
| PO7948 | 6,451,216 | IJM21US |
| PO7951 | 6,231,772 | IJM22US |
| PO8074 | 6,274,056 | IJM23US |
| PO7941 | 6,290,861 | IJM24US |
| PO8077 | 6,248,248 | IJM25US |
| PO8058 | 6,306,671 | IJM26US |
| PO8051 | 6,331,258 | IJM27US |
| PO8045 | 6,110,754 | IJM28US |
| PO7952 | 6,294,101 | IJM29US |
| PO8046 | 6,416,679 | IJM30US |
| PO9390 | 6,264,849 | IJM31US |
| PO9392 | 6,254,793 | IJM32US |
| PP0889 | 6,235,211 | IJM35US |
| PP0887 | 6,491,833 | IJM36US |
| PP0882 | 6,264,850 | IJM37US |
| PP0874 | 6,258,284 | IJM38US |
| PP1396 | 6,312,615 | IJM39US |
| PP3989 | 6,228,668 | IJM40US |
| PP2591 | 6,180,427 | IJM41US |
| PP3990 | 6,171,875 | IJM42US |
| PP3986 | 6,267,904 | IJM43US |
| PP3984 | 6,245,247 | IJM44US |
| PP3982 | 6,315,914 | IJM45US |
| PP0895 | 6,231,148 | IR01US |
| PP0869 | 6,293,658 | IR04US |
| PP0887 | 6,614,560 | IR05US |
| PP0885 | 6,238,033 | IR06US |
| PP0884 | 6,312,070 | IR10US |
| PP0886 | 6,238,111 | IR12US |
| PP0877 | 6,378,970 | IR16US |
| PP0878 | 6,196,739 | IR17US |
| PP0883 | 6,270,182 | IR19US |
| PP0880 | 6,152,619 | IR20US |
| PO8006 | 6,087,638 | MEMS02US |
| PO8007 | 6,340,222 | MEMS03US |
| PO8010 | 6,041,600 | MEMS05US |
| PO8011 | 6,299,300 | MEMS06US |
| PO7947 | 6,067,797 | MEMS07US |
| PO7944 | 6,286,935 | MEMS09US |
| PO7946 | 6,044,646 | MEMS10US |
| PP0894 | 6,382,769 | MEMS13US |

### STATEMENT REGARDING FEDERALLY SPONSORED RESEARCH OR DEVELOPMENT

Not applicable.

### FIELD OF THE INVENTION

The present invention relates to the field of inkjet printing and, in particular, discloses an inverted radial back-curling thermoelastic ink jet printing mechanism.

### BACKGROUND OF THE INVENTION

Many different types of printing mechanisms have been invented, a large number of which are presently in use. The known forms of printers have a variety of methods for marking the print media with a relevant marking media. Commonly used forms of printing include offset printing, laser printing and copying devices, dot matrix type impact printers, thermal paper printers, film recorders, thermal wax printers, dye sublimation printers and ink jet printers both of the drop on demand and continuous flow type. Each type of printer has its own advantages and problems when considering cost, speed, quality, reliability, simplicity of construction and operation etc.

In recent years the field of ink jet printing, wherein each individual pixel of ink is derived from one or more ink nozzles, has become increasingly popular primarily due to its inexpensive and versatile nature.

Many different techniques of ink jet printing have been invented. For a survey of the field, reference is made to an article by J Moore, “Non-Impact Printing: Introduction and Historical Perspective”, Output Hard Copy Devices, Editors R Dubeck and S Sherr, pages 207-220 (1988).

Ink Jet printers themselves come in many different forms. The utilization of a continuous stream of ink in ink jet printing appears to date back to at least 1929 wherein U.S. Pat. No. 1,941,001 by Hansell discloses a simple form of continuous stream electro-static ink jet printing.

U.S. Pat. No. 3,596,275 by Sweet also discloses a process of a continuous ink jet printing including a step wherein the ink jet stream is modulated by a high frequency electro-static field so as to cause drop separation. This technique is still utilized by several manufacturers including Elmjet and Scitex (see also U.S. Pat. No. 3,373,437 by Sweet et al).

Piezoelectric ink jet printers are also one form of commonly utilized ink jet printing device. Piezoelectric systems are disclosed by Kyser et. al. in U.S. Pat. No. 3,946,398 (1970) which utilizes a diaphragm mode of operation, by Zolten in U.S. Pat. No. 3,683,212 (1970) which discloses a squeeze mode form of operation of a piezoelectric crystal, Stemme in U.S. Pat. No. 3,747,120 (1972) which discloses a bend mode of piezoelectric operation, Howkins in U.S. Pat. No. 4,459,601 which discloses a piezoelectric push mode actuation of the ink jet stream and Fischbeck in U.S. Pat. No. 4,584,590 which discloses a shear mode type of piezoelectric transducer element.

Recently, thermal ink jet printing has become an extremely popular form of ink jet printing. The ink jet printing techniques include those disclosed by Endo et al in GB 2007162 (1979) and Vaught et al in U.S. Pat. No. 4,490,728. Both the aforementioned references disclose ink jet printing techniques which rely on the activation of an electrothermal actuator which results in the creation of a bubble in a constricted space, such as a nozzle, which thereby causes the ejection of ink from an aperture connected to the confined space onto a relevant print media. Printing devices utilizing the electro-thermal actuator are manufactured by manufacturers such as Canon and Hewlett Packard.

As can be seen from the foregoing, many different types of printing technologies are available. Ideally, a printing technology should have a number of desirable attributes. These include inexpensive construction and operation, high speed operation, safe and continuous long term operation etc. Each technology may have its own advantages and disadvantages in the areas of cost, speed, quality, reliability, power usage, simplicity of construction and operation, durability and consumables.

### SUMMARY OF THE INVENTION

In accordance with a first aspect of the present invention, there is provided a nozzle arrangement for an ink jet printhead, the arrangement comprising: a nozzle chamber defined in a wafer substrate for the storage of ink to be ejected; an ink ejection port having a rim formed on one wall of the chamber; and a series of actuators attached to the wafer substrate, and forming a portion of the wall of the nozzle chamber adjacent the rim, the actuator paddles further being actuated in unison so as to eject ink from the nozzle chamber via the ink ejection nozzle.

The actuators can include a surface which bends inwards away from the centre of the nozzle chamber upon actuation. The actuators are preferably actuated by means of a thermal actuator device. The thermal actuator device may comprise a conductive resistive heating element encased within a material having a high coefficient of thermal expansion. The element can be serpentine to allow for substantially unhindered expansion of the material. The actuators are preferably arranged radially around the nozzle rim.

The actuators can form a membrane between the nozzle chamber and an external atmosphere of the arrangement and the actuators bend away from the external atmosphere to cause an increase in pressure within the nozzle chamber thereby initiating a consequential ejection of ink from the nozzle chamber. The actuators can bend away from a central axis of the nozzle chamber.

The nozzle arrangement can be formed on the wafer substrate utilizing micro-electro mechanical techniques and further can comprise an ink supply channel in communication with the nozzle chamber. The ink supply channel may be etched through the wafer. The nozzle arrangement may include a series of struts which support the nozzle rim.

The arrangement can be formed adjacent to neighbouring arrangements so as to form a pagewidth printhead.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIGS. 1-3 are schematic sectional views illustrating the operational principles of the preferred embodiment;

FIG. 4(a) and FIG. 4(b) are again schematic sections illustrating the operational principles of the thermal actuator device;

FIG. 5 is a side perspective view, partly in section, of a single nozzle arrangement constructed in accordance with the preferred embodiments;

FIGS. 6-13 are side perspective views, partly in section, illustrating the manufacturing steps of the preferred embodiments;

FIG. 14 illustrates an array of ink jet nozzles formed in accordance with the manufacturing procedures of the preferred embodiment;

FIG. 15 provides a legend of the materials indicated in FIGS. 16 to 23; and

FIG. 16 to FIG. 23 illustrate sectional views of the manufacturing steps in one form of construction of a nozzle arrangement in accordance with the invention.

### DESCRIPTION OF PREFERRED AND OTHER EMBODIMENTS

In the preferred embodiment, ink is ejected out of a nozzle chamber via an ink ejection port using a series of radially positioned thermal actuator devices that are arranged about the ink ejection port and are activated to pressurize the ink within the nozzle chamber thereby causing the ejection of ink through the ejection port.

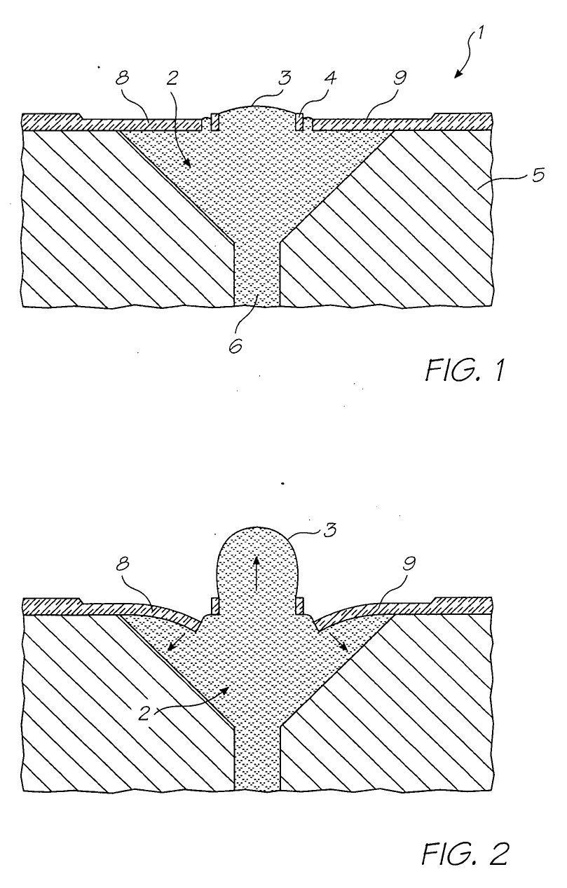

Turning now to FIGS. 1, 2 and 3, there is illustrated the basic operational principles of the preferred embodiment. FIG. 1 illustrates a single nozzle arrangement 1 in its quiescent state. The arrangement 1 includes a nozzle chamber 2 which is normally filled with ink so as to form a meniscus 3 in an ink ejection port 4. The nozzle chamber 2 is formed within a wafer 5. The nozzle chamber 2 is supplied with ink via an ink supply channel 6 which is etched through the wafer 5 with a highly isotropic plasma etching system. A suitable etcher can be the Advance Silicon Etch (ASE) system available from Surface Technology Systems of the United Kingdom.

A top of the nozzle arrangement 1 includes a series of radially positioned actuators 8, 9. These actuators comprise a polytetrafluoroethylene (PTFE) layer and an internal serpentine copper core 17. Upon heating of the copper core 17, the surrounding PTFE expands rapidly resulting in a generally downward movement of the actuators 8, 9. Hence, when it is desired to eject ink from the ink ejection port 4, a current is passed through the actuators 8, 9 which results in them bending generally downwards as illustrated in FIG. 2. The downward bending movement of the actuators 8, 9 results in a substantial increase in pressure within the nozzle chamber 2. The increase in pressure in the nozzle chamber 2 results in an expansion of the meniscus 3 as illustrated in FIG. 2.

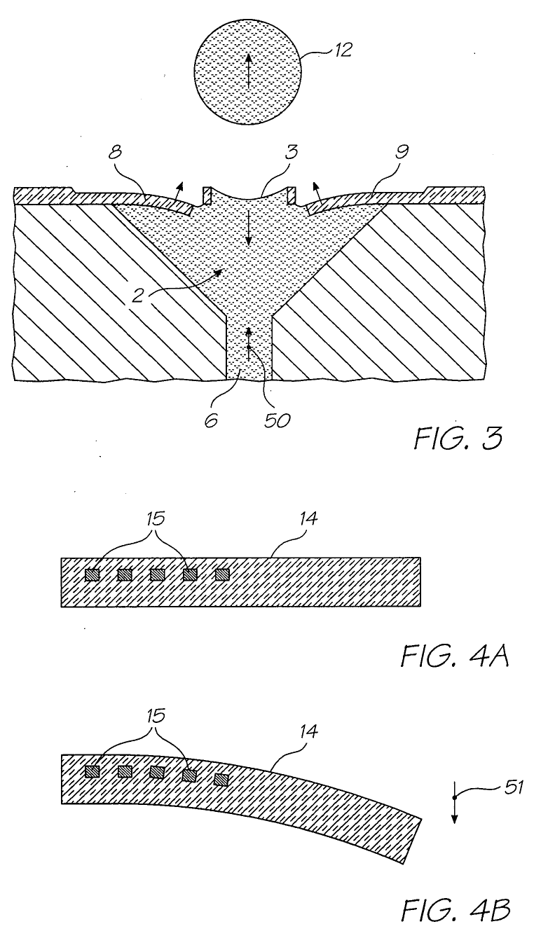

The actuators 8, 9 are activated only briefly and subsequently deactivated. Consequently, the situation is as illustrated in FIG. 3 with the actuators 8, 9 returning to their original positions. This results in a general inflow of ink back into the nozzle chamber 2 and a necking and breaking of the meniscus 3 resulting in the ejection of a drop 12. The necking and breaking of the meniscus 3 is a consequence of the forward momentum of the ink associated with drop 12 and the backward pressure experienced as a result of the return of the actuators 8, 9 to their original positions. The return of the actuators 8,9 also results in a general inflow of ink from the channel 6 as a result of surface tension effects and, eventually, the state returns to the quiescent position as illustrated in FIG. 1.

FIGS. 4(a) and 4(b) illustrate the principle of operation of the thermal actuator. The thermal actuator is preferably constructed from a material 14 having a high coefficient of thermal expansion. Embedded within the material 14 are a series of heater elements 15 which can be a series of conductive elements designed to carry a current. The conductive elements 15 are heated by passing a current through the elements 15 with the heating resulting in a general increase in temperature in the area around the heating elements 15. The position of the elements 15 is such that uneven heating of the material 14 occurs. The uneven increase in temperature causes a corresponding uneven expansion of the material 14. Hence, as illustrated in FIG. 4(b), the PTFE is bent generally in the direction shown.

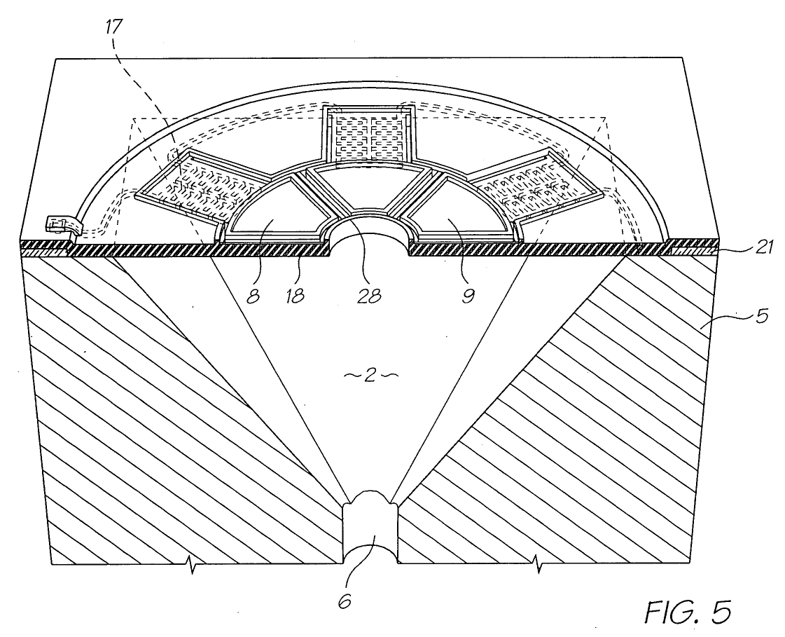

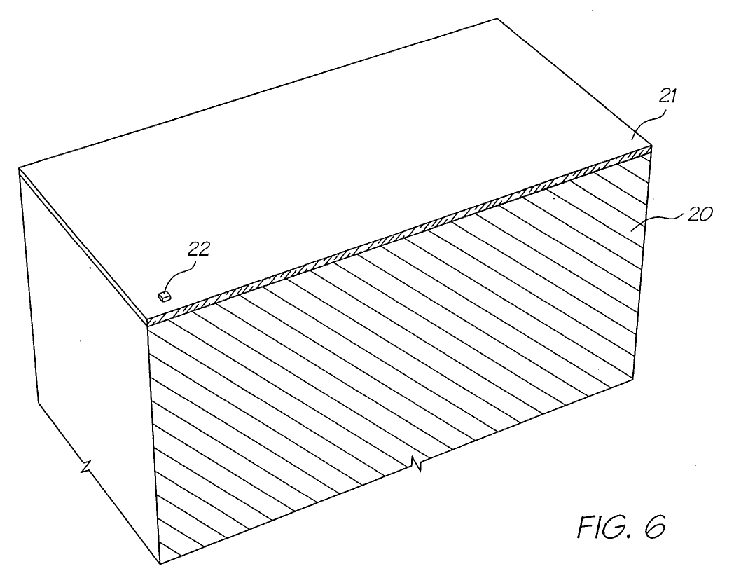

In FIG. 5, there is illustrated a side perspective view of one embodiment of a nozzle arrangement constructed in accordance with the principles previously outlined. The nozzle chamber 2 is formed with an isotropic surface etch of the wafer 5. The wafer 5 can include a CMOS layer including all the required power and drive circuits. Further, the actuators 8, 9 each have a leaf or petal formation which extends towards a nozzle rim 28 defining the ejection port 4. The normally inner end of each leaf or petal formation is displaceable with respect to the nozzle rim 28. Each activator 8, 9 has an internal copper core 17 defining the element 15. The core 17 winds in a serpentine manner to provide for substantially unhindered expansion of the actuators 8, 9. The operation of the actuators 8, 9 is as illustrated in FIG. 4(a) and FIG. 4(b) such that, upon activation, the actuators 8 bend as previously described resulting in a displacement of each petal formation away from the nozzle rim 28 and into the nozzle chamber 2. The ink supply channel 6 can be created via a deep silicon back edge of the wafer 5 utilizing a plasma etcher or the like. The copper or aluminium core 17 can provide a complete circuit. A central arm 18 which can include both metal and PTFE portions provides the main structural support for the actuators 8, 9.

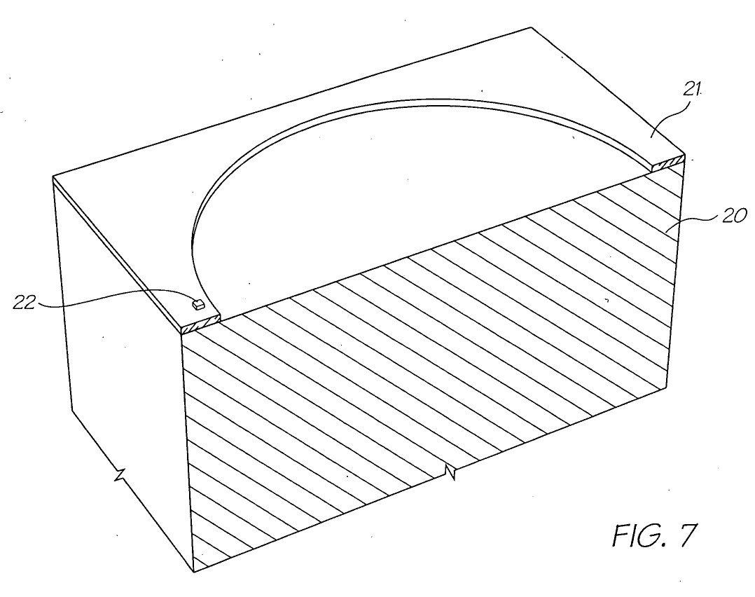

Turning now to FIG. 6 to FIG. 13, one form of manufacture of the nozzle arrangement 1 in accordance with the principles of the preferred embodiment is shown. The nozzle arrangement 1 is preferably manufactured using microelectromechanical (MEMS) techniques and can include the following construction techniques:

As shown initially in FIG. 6, the initial processing starting material is a standard semi-conductor wafer 20 having a complete CMOS level 21 to a first level of metal. The first level of metal includes portions 22 which are utilized for providing power to the thermal actuators 8, 9.

The first step, as illustrated in FIG. 7, is to etch a nozzle region down to the silicon wafer 20 utilizing an appropriate mask.

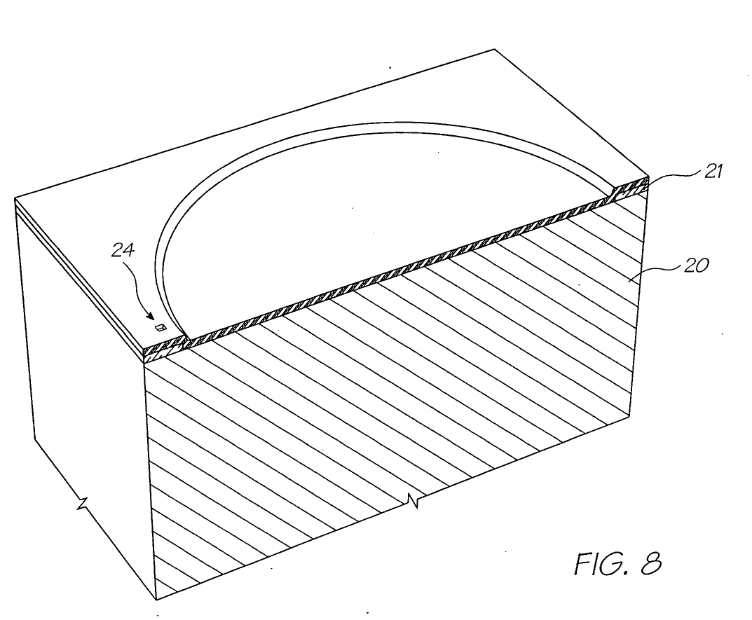

Next, as illustrated in FIG. 8, a 2 μm layer of polytetrafluoroethylene (PTFE) is deposited and etched so as to define vias 24 for interconnecting multiple levels.

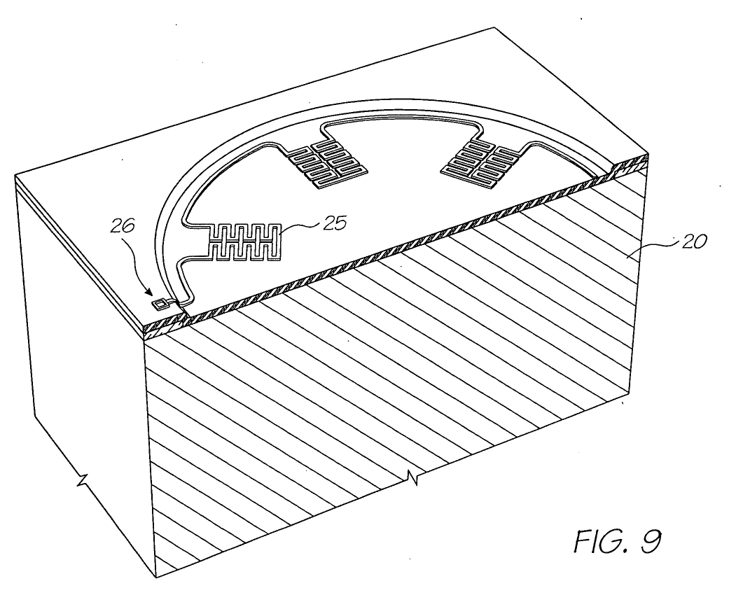

Next, as illustrated in FIG. 9, the second level metal layer is deposited, masked and etched to define a heater structure 25. The heater structure 25 includes via 26 interconnected with a lower aluminium layer.

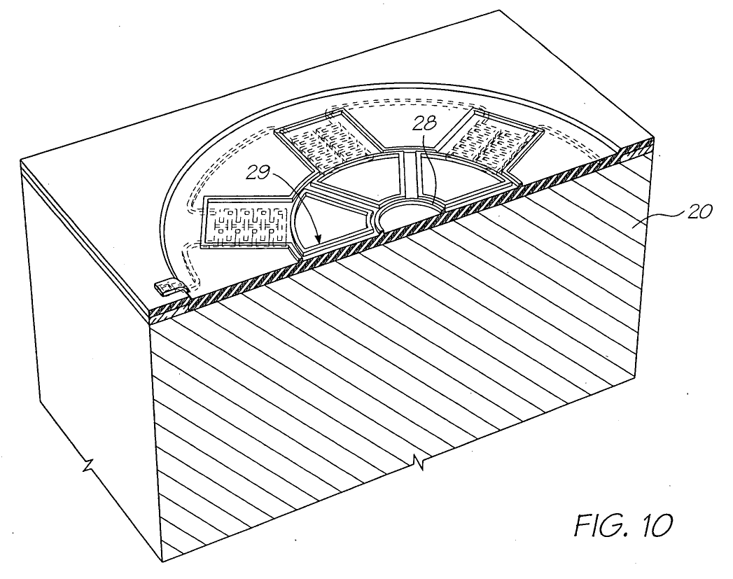

Next, as illustrated in FIG. 10, a further 2 μm layer of PTFE is deposited and etched to the depth of 1 μm utilizing a nozzle rim mask to define the nozzle rim 28 in addition to ink flow guide rails 29 which generally restrain any wicking along the surface of the PTFE layer. The guide rails 29 surround small thin slots and, as such, surface tension effects are a lot higher around these slots which in turn results in minimal outflow of ink during operation.

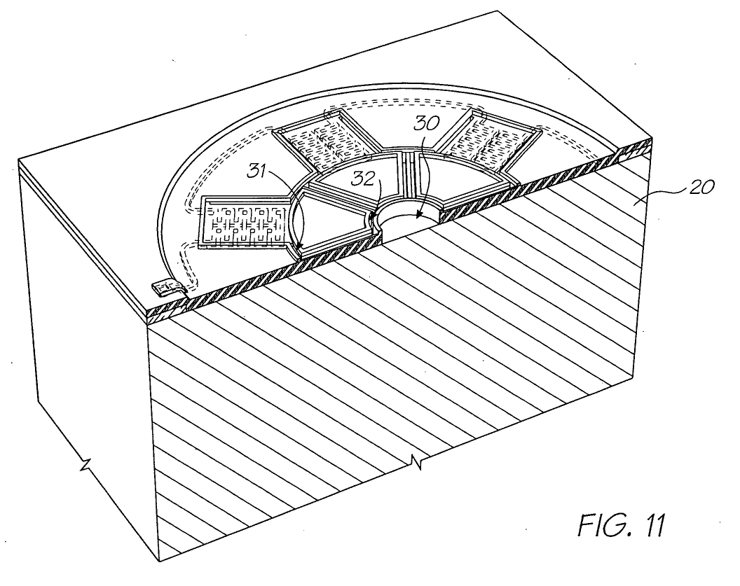

Next, as illustrated in FIG. 11, the PTFE is etched utilizing a nozzle and actuator mask to define a port portion 30 and slots 31 and 32.

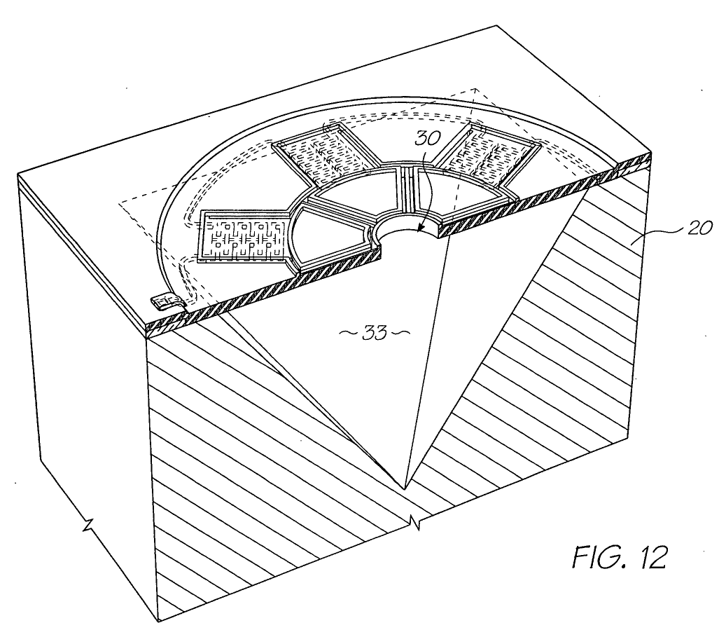

Next, as illustrated in FIG. 12, the wafer is crystallographically etched on a <111> plane utilizing a standard crystallographic etchant such as KOH. The etching forms a chamber 33, directly below the port portion 30.

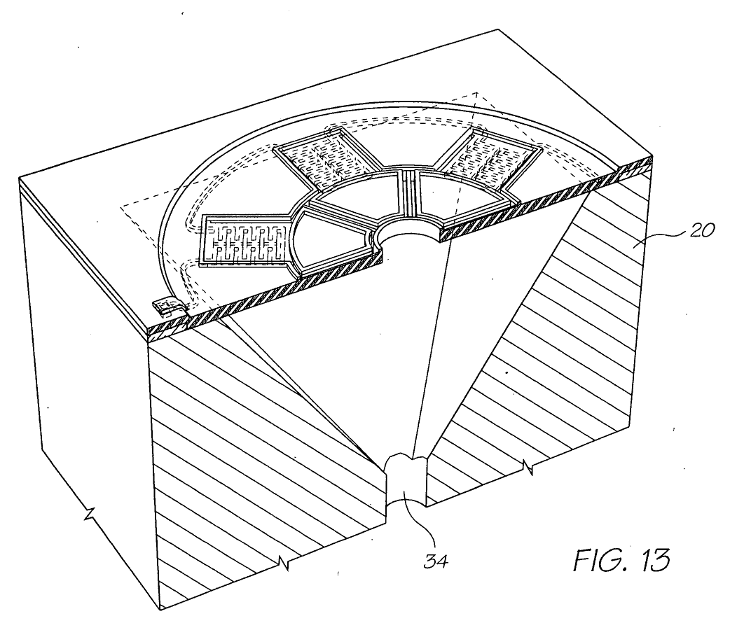

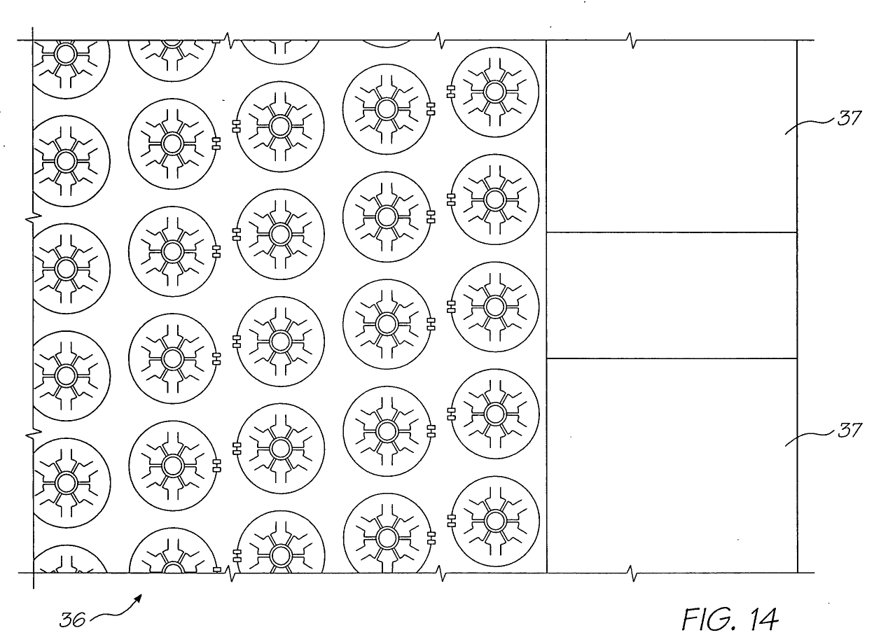

In FIG. 13, the ink supply channel 34 can be etched from the back of the wafer utilizing a highly anisotropic etcher such as the STS etcher from Silicon Technology Systems of United Kingdom. An array of ink jet nozzles can be formed simultaneously with a portion of an array 36 being illustrated in FIG. 14. A portion of the printhead is formed simultaneously and diced by the STS etching process. The array 36 shown provides for four column printing with each separate column attached to a different colour ink supply channel being supplied from the back of the wafer. Bond pads 37 provide for electrical control of the ejection mechanism.

In this manner, large pagewidth printheads can be fabricated so as to provide for a drop-on-demand ink ejection mechanism.

One form of detailed manufacturing process which can be used to fabricate monolithic ink jet printheads operating in accordance with the principles taught by the present embodiment can proceed utilizing the following steps:

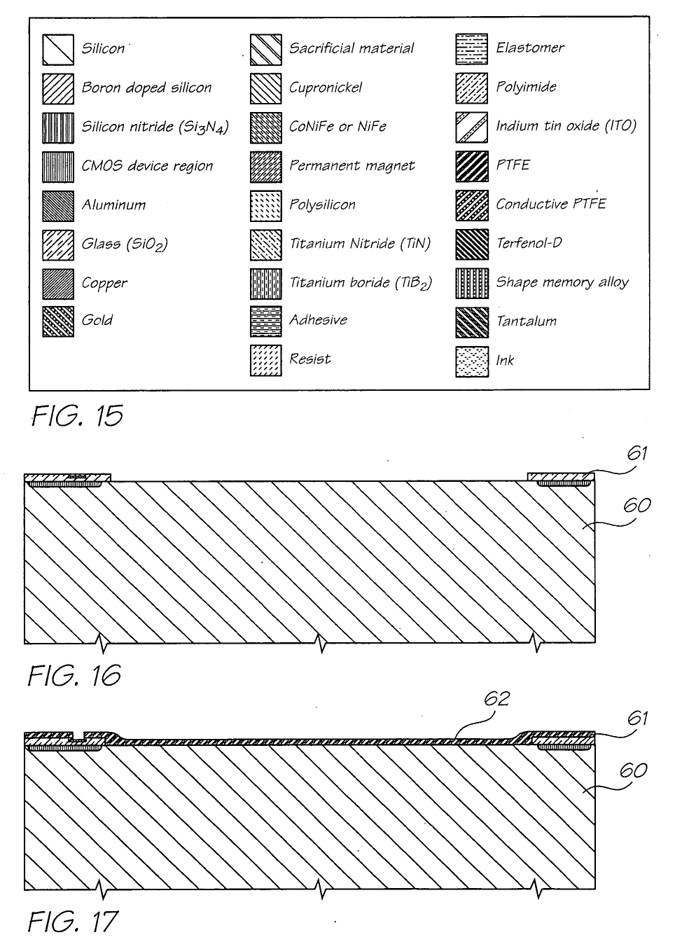

1. Using a double-sided polished wafer 60, complete a 0.5 micron, one poly, 2 metal CMOS process 61. This step is shown in FIG. 16. For clarity, these diagrams may not be to scale, and may not represent a cross section though any single plane of the nozzle. FIG. 15 is a key to representations of various materials in these manufacturing diagrams, and those of other cross referenced ink jet configurations.

2. Etch the CMOS oxide layers down to silicon or second level metal using Mask 1. This mask defines the nozzle cavity and the edge of the chips. This step is shown in FIG. 16.

3. Deposit a thin layer (not shown) of a hydrophilic polymer, and treat the surface of this polymer for PTFE adherence.

4. Deposit 1.5 microns of polytetrafluoroethylene (PTFE) 62.

5. Etch the PTFE and CMOS oxide layers to second level metal using Mask 2. This mask defines the contact vias for the heater electrodes. This step is shown in FIG. 17.

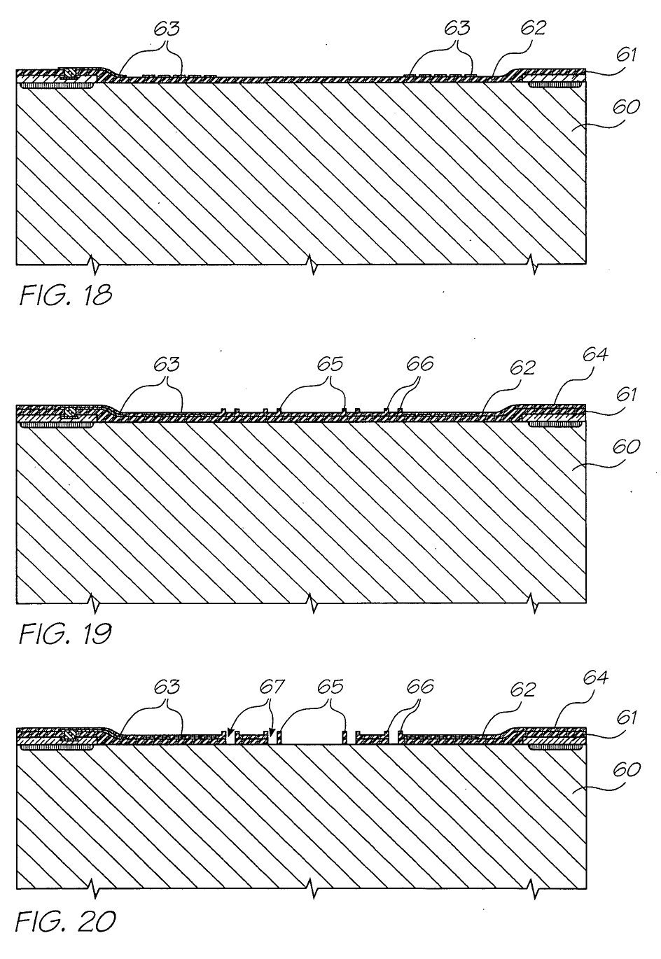

6. Deposit and pattern 0.5 microns of gold 63 using a lift-off process using Mask 3. This mask defines the heater pattern. This step is shown in FIG. 18.

7. Deposit 1.5 microns of PTFE 64.

8. Etch 1 micron of PTFE using Mask 4. This mask defines the nozzle rim 65 and the rim at the edge 66 of the nozzle chamber. This step is shown in FIG. 19.

9. Etch both layers of PTFE and the thin hydrophilic layer down to silicon using Mask 5. This mask defines a gap 67 at inner edges of the actuators, and the edge of the chips. It also forms the mask for a subsequent crystallographic etch. This step is shown in FIG. 20.

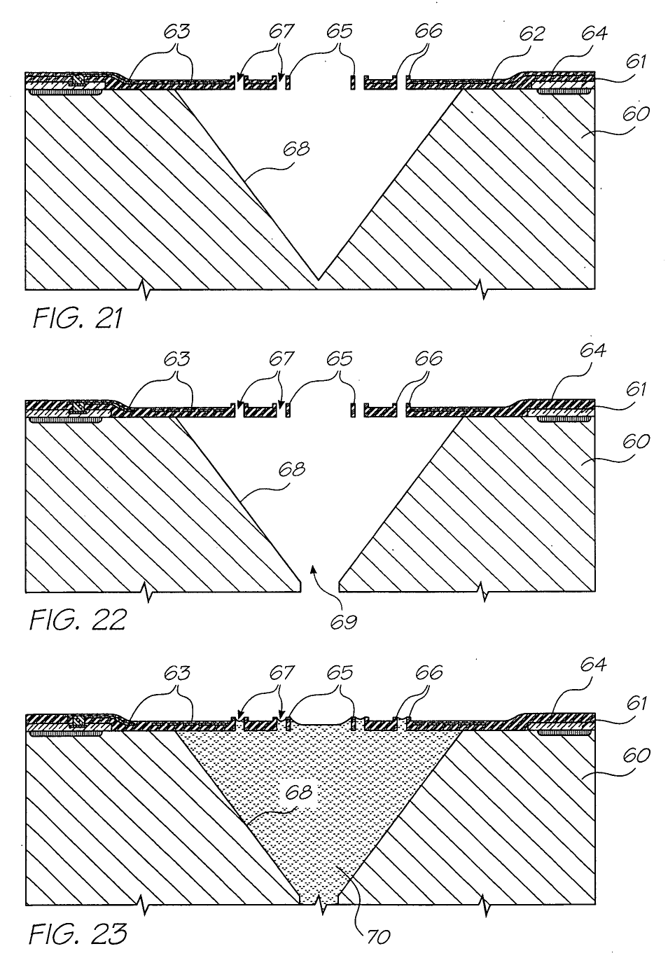

10. Crystallographically etch the exposed silicon using KOH. This etch stops on <111> crystallographic planes 68, forming an inverted square pyramid with sidewall angles of 54.74 degrees. This step is shown in FIG. 21.

11. Back-etch through the silicon wafer (with, for example, an ASE Advanced Silicon Etcher from Surface Technology Systems) using Mask 6. This mask defines the ink inlets 69 which are etched through the wafer. The wafer is also diced by this etch. This step is shown in FIG. 22.

12. Mount the printheads in their packaging, which may be a molded plastic former incorporating ink channels which supply the appropriate color ink to the ink inlets 69 at the back of the wafer.

13. Connect the printheads to their interconnect systems. For a low profile connection with minimum disruption of airflow, TAB may be used. Wire bonding may also be used if the printer is to be operated with sufficient clearance to the paper.

14. Fill the completed print heads with ink 70 and test them. A filled nozzle is shown in FIG. 23.

The presently disclosed ink jet printing technology is potentially suited to a wide range of printing systems including: color and monochrome office printers, short run digital printers, high speed digital printers, offset press supplemental printers, low cost scanning printers high speed pagewidth printers, notebook computers with inbuilt pagewidth printers, portable color and monochrome printers, color and monochrome copiers, color and monochrome facsimile machines, combined printer, facsimile and copying machines, label printers, large format plotters, photograph copiers, printers for digital photographic “minilabs”, video printers, PHOTO CD (PHOTO CD is a registered trade mark of the Eastman Kodak Company) printers, portable printers for PDAs, wallpaper printers, indoor sign printers, billboard printers, fabric printers, camera printers and fault tolerant commercial printer arrays.

It would be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

### Ink Jet Technologies

The embodiments of the invention use an ink jet printer type device. Of course many different devices could be used. However presently popular ink jet printing technologies are unlikely to be suitable.

The most significant problem with thermal ink jet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal ink jet applications. This leads to an efficiency of around 0.02%, from electricity input to drop momentum (and increased surface area) out.

The most significant problem with piezoelectric ink jet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per printhead, but is a major impediment to the fabrication of pagewidth printheads with 19,200 nozzles.

Ideally, the ink jet technologies used meet the stringent requirements of in-camera digital color printing and other high quality, high speed, low cost printing applications. To meet the requirements of digital photography, new ink jet technologies have been created. The target features include:

low power (less than 10 Watts)

high resolution capability (1,600 dpi or more)

photographic quality output

low manufacturing cost

small size (pagewidth times minimum cross section)

high speed (<2 seconds per page).

All of these features can be met or exceeded by the ink jet systems described below with differing levels of difficulty. Forty-five different ink jet technologies have been developed by the Assignee to give a wide range of choices for high volume manufacture. These technologies form part of separate applications assigned to the present Assignee as set out in the table below under the heading Cross References to Related Applications.

The ink jet designs shown here are suitable for a wide range of digital printing systems, from battery powered one-time use digital cameras, through to desktop and network printers, and through to commercial printing systems.

For ease of manufacture using standard process equipment, the printhead is designed to be a monolithic 0.5 micron CMOS chip with MEMS post processing. For color photographic applications, the printhead is 100 mm long, with a width which depends upon the ink jet type. The smallest printhead designed is IJ38, which is 0.35 mm wide, giving a chip area of 35 square mm. The printheads each contain 19,200 nozzles plus data and control circuitry.

Ink is supplied to the back of the printhead by injection molded plastic ink channels. The molding requires 50 micron features, which can be created using a lithographically micromachined insert in a standard injection molding tool. Ink flows through holes etched through the wafer to the nozzle chambers fabricated on the front surface of the wafer. The printhead is connected to the camera circuitry by tape automated bonding.

### Tables of Drop-on-Demand Ink Jets

Eleven important characteristics of the fundamental operation of individual ink jet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of ink jet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of ink jet nozzle. While not all of the possible combinations result in a viable ink jet technology, many million configurations are viable. It is clearly impractical to elucidate all of the possible configurations. Instead, certain ink jet types have been investigated in detail. These are designated IJ01 to IJ45 above which matches the docket numbers in the table under the heading Cross References to Related Applications.

Other ink jet configurations can readily be derived from these forty-five examples by substituting alternative configurations along one or more of the 11 axes. Most of the IJ01 to IJ45 examples can be made into ink jet printheads with characteristics superior to any currently available ink jet technology.

Where there are prior art examples known to the inventor, one or more of these examples are listed in the examples column of the tables below. The IJ01 to IJ45 series are also listed in the examples column. In some cases, print technology may be listed more than once in a table, where it shares characteristics with more than one entry.

Suitable applications for the ink jet technologies include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

ACTUATOR MECHANISM (APPLIED ONLY TO SELECTED INK DROPS)

| | Description | Advantages | Disadvantages | Examples |
|---|---|---|---|---|
| Thermal | An electrothermal | Large force | High power | Canon |
| bubble | heater heats the | generated | Ink carrier | Bubblejet 1979 |
| | ink to above | Simple | limited to water | Endo et al GB |
| | boiling point, | construction | Low | patent 2,007,162 |
| | transferring | No moving | efficiency | Xerox heater- |
| | significant heat to | parts | High | in-pit 1990 |
| | the aqueous ink. A | Fast operation | temperatures | Hawkins et al |
| | bubble nucleates | Small chip | required | U.S. Pat. No. 4,899,181 |
| | and quickly forms, | area required for | High | Hewlett- |
| | expelling the ink. | actuator | mechanical | Packard TIJ |
| | The efficiency of | | stress | 1982 Vaught et |
| | the process is low, | | Unusual | al U.S. Pat. No. |
| | with typically less | | materials | 4,490,728 |
| | than 0.05% of the | | required | |
| | electrical energy | | Large drive | |
| | being transformed | | transistors | |
| | into kinetic energy | | Cavitation | |
| | of the drop. | | causes actuator | |
| | | | failure | |
| | | | Kogation | |
| | | | reduces bubble | |
| | | | formation | |
| | | | Large print | |
| | | | heads are | |
| | | | difficult to | |
| | | | fabricate | |
| Piezo- | A piezoelectric | Low power | Very large | Kyser et al |
| electric | crystal such as | consumption | area required for | U.S. Pat. No. 3,946,398 |
| | lead lanthanum | Many ink | actuator | Zoltan U.S. Pat. No. |
| | zirconate (PZT) is | types can be | Difficult to | 3,683,212 |
| | electrically | used | integrate with | 1973 Stemme |
| | activated, and | Fast operation | electronics | U.S. Pat. No. 3,747,120 |
| | either expands, | High | High voltage | Epson Stylus |
| | shears, or bends to | efficiency | drive transistors | Tektronix |
| | apply pressure to | | required | IJ04 |
| | the ink, ejecting | | Full | |
| | drops. | | pagewidth print | |
| | | | heads | |
| | | | impractical due | |
| | | | to actuator size | |
| | | | Requires | |
| | | | electrical poling | |
| | | | in high field | |
| | | | strengths during | |
| | | | manufacture | |
| Electro- | An electric field is | Low power | Low | Seiko Epson, |
| strictive | used to activate | consumption | maximum strain | Usui et all JP |
| | electrostriction in | Many ink | (approx. 0.01%) | 253401/96 |
| | relaxor materials | types can be | Large area | IJ04 |
| | such as lead | used | required for | |
| | lanthanum | Low thermal | actuator due to | |
| | zirconate titanate | expansion | low strain | |
| | (PLZT) or lead | Electric field | Response | |
| | magnesium | strength required | speed is | |
| | niobate (PMN). | (approx. 3.5 V/μm) | marginal (~10 μs) | |
| | | can be | High voltage | |
| | | generated | drive transistors | |
| | | without | required | |
| | | difficulty | Full | |
| | | Does not | pagewidth print | |
| | | require electrical | heads | |
| | | poling | impractical due | |
| | | | to actuator size | |
| Ferro- | An electric field is | Low power | Difficult to | IJ04 |
| electric | used to induce a | consumption | integrate with | |
| | phase transition | Many ink | electronics | |
| | between the | types can be | Unusual | |
| | antiferroelectric | used | materials such as | |
| | (AFE) and | Fast operation | PLZSnT are | |
| | ferroelectric (FE) | (<1 μs) | required | |
| | phase. Perovskite | Relatively | Actuators | |
| | materials such as | high longitudinal | require a large | |
| | tin modified lead | strain | area | |
| | lanthanum | High | | |
| | zirconate titanate | efficiency | | |
| | (PLZSnT) exhibit | Electric field | | |
| | large strains of up | strength of | | |
| | to 1% associated | around 3 V/μm | | |
| | with the AFE to | can be readily | | |
| | FE phase | provided | | |
| | transition. | | | |
| Electro- | Conductive plates | Low power | Difficult to | IJ02, IJ04 |
| static | are separated by a | consumption | operate | |
| plates | compressible or | Many ink | electrostatic | |
| | fluid dielectric | types can be | devices in an | |
| | (usually air). Upon | used | aqueous | |
| | application of a | Fast operation | environment | |
| | voltage, the plates | | The | |
| | attract each other | | electrostatic | |
| | and displace ink, | | actuator will | |
| | causing drop | | normally need to | |
| | ejection. The | | be separated | |
| | conductive plates | | from the ink | |
| | may be in a comb | | Very large | |
| | or honeycomb | | area required to | |
| | structure, or | | achieve high | |
| | stacked to increase | | forces | |
| | the surface area | | High voltage | |
| | and therefore the | | drive transistors | |
| | force. | | may be required | |
| | | | Full | |
| | | | pagewidth print | |
| | | | heads are not | |
| | | | competitive due | |
| | | | to actuator size | |
| Electro- | A strong electric | Low current | High voltage | 1989 Saito et |
| static pull | field is applied to | consumption | required | al, U.S. Pat. No. |
| on ink | the ink, whereupon | Low | May be | 4,799,068 |
| | electrostatic | temperature | damaged by | 1989 Miura et |
| | attraction | | sparks due to air | al, U.S. Pat. No. |
| | accelerates the ink | | breakdown | 4,810,954 |
| | towards the print | | Required field | Tone-jet |
| | medium. | | strength | |
| | | | increases as the | |
| | | | drop size | |
| | | | decreases | |
| | | | High voltage | |
| | | | drive transistors | |
| | | | required | |
| | | | Electrostatic | |
| | | | field attracts dust | |
| Permanent | An electromagnet | Low power | Complex | IJ07, IJ10 |
| magnet | directly attracts a | consumption | fabrication | |
| electro- | permanent magnet, | Many ink | Permanent | |
| magnetic | displacing ink and | types can be | magnetic | |
| | causing drop | used | material such as | |
| | ejection. Rare | Fast operation | Neodymium Iron | |
| | earth magnets with | High | Boron (NdFeB) | |
| | a field strength | efficiency | required. | |
| | around 1 Tesla can | Easy | High local | |
| | be used. Examples | extension from | currents required | |
| | are: Samarium | single nozzles to | Copper | |
| | Cobalt (SaCo) and | pagewidth print | metalization | |
| | magnetic materials | heads | should be used | |
| | in the neodymium | | for long | |
| | iron boron family | | electromigration | |
| | (NdFeB, | | lifetime and low | |
| | NdDyFeBNb, | | resistivity | |
| | NdDyFeB, etc) | | Pigmented | |
| | | | inks are usually | |
| | | | infeasible | |
| | | | Operating | |
| | | | temperature | |
| | | | limited to the | |
| | | | Curie | |
| | | | temperature | |
| | | | (around 540 K) | |
| Soft | A solenoid | Low power | Complex | IJ01, IJ05, |
| magnetic | induced a | consumption | fabrication | IJ08, IJ10, IJ12, |
| core | magnetic field in a | Many ink | Materials not | IJ14, IJ15, IJ17 |
| electro- | soft magnetic core | types can be | usually present | |
| magnetic | or yoke fabricated | used | in a CMOS fab | |
| | from a ferrous | Fast operation | such as NiFe, | |
| | material such as | High | CoNiFe, or CoFe | |
| | electroplated iron | efficiency | are required | |
| | alloys such as | Easy | High local | |
| | CoNiFe [1], CoFe, | extension from | currents required | |
| | or NiFe alloys. | single nozzles to | Copper | |
| | Typically, the soft | pagewidth print | metalization | |
| | magnetic material | heads | should be used | |
| | is in two parts, | | for long | |
| | which are | | electromigration | |
| | normally held | | lifetime and low | |
| | apart by a spring. | | resistivity | |
| | When the solenoid | | Electroplating | |
| | is actuated, the two | | is required | |
| | parts attract, | | High | |
| | displacing the ink. | | saturation flux | |
| | | | density is | |
| | | | required (2.0-2.1 | |
| | | | T is achievable | |
| | | | with CoNiFe | |
| | | | [1]) | |
| Lorenz | The Lorenz force | Low power | Force acts as a | IJ06, IJ11, |
| force | acting on a current | consumption | twisting motion | IJ13, IJ16 |
| | carrying wire in a | Many ink | Typically, | |
| | magnetic field is | types can be | only a quarter of | |
| | utilized. | used | the solenoid | |
| | This allows the | Fast operation | length provides | |
| | magnetic field to | High | force in a useful | |
| | be supplied | efficiency | direction | |
| | externally to the | Easy | High local | |
| | print head, for | extension from | currents required | |
| | example with rare | single nozzles to | Copper | |
| | earth permanent | pagewidth print | metalization | |
| | magnets. | heads | should be used | |
| | Only the current | | for long | |
| | carrying wire need | | electromigration | |
| | be fabricated on | | lifetime and low | |
| | the print-head, | | resistivity | |
| | simplifying | | Pigmented | |
| | materials | | inks are usually | |
| | requirements. | | infeasible | |
| Magneto- | The actuator uses | Many ink | Force acts as a | Fischenbeck, |
| striction | the giant | types can be | twisting motion | U.S. Pat. No. 4,032,929 |
| | magnetostrictive | used | Unusual | IJ25 |
| | effect of materials | Fast operation | materials such as | |
| | such as Terfenol-D | Easy | Terfenol-D are | |
| | (an alloy of | extension from | required | |
| | terbium, | single nozzles to | High local | |
| | dysprosium and | pagewidth print | currents required | |
| | iron developed at | heads | Copper | |
| | the Naval | High force is | metalization | |
| | Ordnance | available | should be used | |
| | Laboratory, hence | | for long | |
| | Ter-Fe-NOL). For | | electromigration | |
| | best efficiency, the | | lifetime and low | |
| | actuator should be | | resistivity | |
| | pre-stressed to | | Pre-stressing | |
| | approx. 8 MPa. | | may be required | |
| Surface | Ink under positive | Low power | Requires | Silverbrook, |
| tension | pressure is held in | consumption | supplementary | EP 0771 658 A2 |
| reduction | a nozzle by surface | Simple | force to effect | and related |
| | tension. The | construction | drop separation | patent |
| | surface tension of | No unusual | Requires | applications |
| | the ink is reduced | materials | special ink | |
| | below the bubble | required in | surfactants | |
| | threshold, causing | fabrication | Speed may be | |
| | the ink to egress | High | limited by | |
| | from the nozzle. | efficiency | surfactant | |
| | | Easy | properties | |
| | | extension from | | |
| | | single nozzles to | | |
| | | pagewidth print | | |
| | | heads | | |
| Viscosity | The ink viscosity | Simple | Requires | Silverbrook, |
| reduction | is locally reduced | construction | supplementary | EP 0771 658 A2 |
| | to select which | No unusual | force to effect | and related |
| | drops are to be | materials | drop separation | patent |
| | ejected. A | required in | Requires | applications |
| | viscosity reduction | fabrication | special ink | |
| | can be achieved | Easy | viscosity | |
| | electrothermally | extension from | properties | |
| | with most inks, but | single nozzles to | High speed is | |
| | special inks can be | pagewidth print | difficult to | |
| | engineered for a | heads | achieve | |
| | 100:1 viscosity | | Requires | |
| | reduction. | | oscillating ink | |
| | | | pressure | |
| | | | A high | |
| | | | temperature | |
| | | | difference | |
| | | | (typically 80 | |
| | | | degrees) is | |
| | | | required | |
| Acoustic | An acoustic wave | Can operate | Complex | 1993 |
| | is generated and | without a nozzle | drive circuitry | Hadimioglu et |
| | focussed upon the | plate | Complex | al, EUP 550,192 |
| | drop ejection | | fabrication | 1993 Elrod et |
| | region. | | Low | al, EUP 572,220 |
| | | | efficiency | |
| | | | Poor control | |
| | | | of drop position | |
| | | | Poor control | |
| | | | of drop volume | |
| Thermo- | An actuator which | Low power | Efficient | IJ03, IJ09, |
| elastic | relies upon | consumption | aqueous | IJ17, IJ18, IJ19, |
| bend | differential | Many ink | operation | IJ20, IJ21, IJ22, |
| actuator | thermal expansion | types can be | requires a | IJ23, IJ24, IJ27, |
| | upon Joule heating | used | thermal insulator | IJ28, IJ29, IJ30, |
| | is used. | Simple planar | on the hot side | IJ31, IJ32, IJ33, |
| | | fabrication | Corrosion | IJ34, IJ35, IJ36, |
| | | Small chip | prevention can | IJ37, IJ38, IJ39, |
| | | area required for | be difficult | IJ40, IJ41 |
| | | each actuator | Pigmented | |
| | | Fast operation | inks may be | |
| | | High | infeasible, as | |
| | | efficiency | pigment particles | |
| | | CMOS | may jam the | |
| | | compatible | bend actuator | |
| | | voltages and | | |
| | | currents | | |
| | | Standard | | |
| | | MEMS | | |
| | | processes can be | | |
| | | used | | |
| | | Easy | | |
| | | extension from | | |
| | | single nozzles to | | |
| | | pagewidth print | | |
| | | heads | | |
| High CTE | A material with a | High force | Requires | IJ09, IJ17, |
| thermo- | very high | can be generated | special material | IJ18, IJ20, IJ21, |
| elastic | coefficient of | Three | (e.g. PTFE) | IJ22, IJ23, IJ24, |
| actuator | thermal expansion | methods of | Requires a | IJ27, IJ28, IJ29, |
| | (CTE) such as | PTFE deposition | PTFE deposition | IJ30, IJ31, IJ42, |
| | polytetrafluoroethylene | are under | process, which is | IJ43, IJ44 |
| | (PTFE) is | development: | not yet standard | |
| | used. As high CTE | chemical vapor | in ULSI fabs | |
| | materials are | deposition | PTFE | |
| | usually non- | (CVD), spin | deposition | |
| | conductive, a | coating, and | cannot be | |
| | heater fabricated | evaporation | followed with | |
| | from a conductive | PTFE is a | high temperature | |
| | material is | candidate for | (above 350° C.) | |
| | incorporated. A 50 μm | low dielectric | processing | |
| | long PTFE | constant | Pigmented | |
| | bend actuator with | insulation in | inks may be | |
| | polysilicon heater | ULSI | infeasible, as | |
| | and 15 mW power | Very low | pigment particles | |
| | input can provide | power | may jam the | |
| | 180 μN force and | consumption | bend actuator | |
| | 10 μm deflection. | Many ink | | |
| | Actuator motions | types can be | | |
| | include: | used | | |
| | Bend | Simple planar | | |
| | Push | fabrication | | |
| | Buckle | Small chip | | |
| | Rotate | area required for | | |
| | | each actuator | | |
| | | Fast operation | | |
| | | High | | |
| | | efficiency | | |
| | | CMOS | | |
| | | compatible | | |
| | | voltages and | | |
| | | currents | | |
| | | Easy | | |
| | | extension from | | |
| | | single nozzles to | | |
| | | pagewidth print | | |
| | | heads | | |
| Conductive | A polymer with a | High force | Requires | IJ24 |
| polymer | high coefficient of | can be generated | special materials | |
| thermo- | thermal expansion | Very low | development | |
| elastic | (such as PTFE) is | power | (High CTE | |
| actuator | doped with | consumption | conductive | |
| | conducting | Many ink | polymer) | |
| | substances to | types can be | Requires a | |
| | increase its | used | PTFE deposition | |
| | conductivity to | Simple planar | process, which is | |
| | about 3 orders of | fabrication | not yet standard | |
| | magnitude below | Small chip | in ULSI fabs | |
| | that of copper. The | area required for | PTFE | |
| | conducting | each actuator | deposition | |
| | polymer expands | Fast operation | cannot be | |
| | when resistively | High | followed with | |
| | heated. | efficiency | high temperature | |
| | Examples of | CMOS | (above 350° C.) | |
| | conducting | compatible | processing | |
| | dopants include: | voltages and | Evaporation | |
| | Carbon nanotubes | currents | and CVD | |
| | Metal fibers | Easy | deposition | |
| | Conductive | extension from | techniques | |
| | polymers such as | single nozzles to | cannot be used | |
| | doped | pagewidth print | Pigmented | |
| | polythiophene | heads | inks may be | |
| | Carbon granules | | infeasible, as | |
| | | | pigment particles | |
| | | | may jam the | |
| | | | bend actuator | |
| Shape | A shape memory | High force is | Fatigue limits | IJ26 |
| memory | alloy such as TiNi | available | maximum | |
| alloy | (also known as | (stresses of | number of cycles | |
| | Nitinol - Nickel | hundreds of | Low strain | |
| | Titanium alloy | MPa) | (1%) is required | |
| | developed at the | Large strain is | to extend fatigue | |
| | Naval Ordnance | available (more | resistance | |
| | Laboratory) is | than 3%) | Cycle rate | |
| | thermally switched | High | limited by heat | |
| | between its weak | corrosion | removal | |
| | martensitic state | resistance | Requires | |
| | and its high | Simple | unusual | |
| | stiffness austenic | construction | materials (TiNi) | |
| | state. The shape of | Easy | The latent | |
| | the actuator in its | extension from | heat of | |
| | martensitic state is | single nozzles to | transformation | |
| | deformed relative | pagewidth print | must be | |
| | to the austenic | heads | provided | |
| | shape. The shape | Low voltage | High current | |
| | change causes | operation | operation | |
| | ejection of a drop. | | Requires pre- | |
| | | | stressing to | |
| | | | distort the | |
| | | | martensitic state | |
| Linear | Linear magnetic | Linear | Requires | IJ12 |
| Magnetic | actuators include | Magnetic | unusual | |
| Actuator | the Linear | actuators can be | semiconductor | |
| | Induction Actuator | constructed with | materials such as | |
| | (LIA), Linear | high thrust, long | soft magnetic | |
| | Permanent Magnet | travel, and high | alloys (e.g. | |
| | Synchronous | efficiency using | CoNiFe) | |
| | Actuator | planar | Some varieties | |
| | (LPMSA), Linear | semiconductor | also require | |
| | Reluctance | fabrication | permanent | |
| | Synchronous | techniques | magnetic | |
| | Actuator (LRSA), | Long actuator | materials such as | |
| | Linear Switched | travel is | Neodymium iron | |
| | Reluctance | available | boron (NdFeB) | |
| | Actuator (LSRA), | Medium force | Requires | |
| | and the Linear | is available | complex multi- | |
| | Stepper Actuator | Low voltage | phase drive | |
| | (LSA). | operation | circuitry | |
| | | | High current | |
| | | | operation | |

| | | | |
|---|---|---|---|
| Description | Advantages | Disadvantages | Examples |

BASIC OPERATION MODE

| | | | | |
|---|---|---|---|---|
| Actuator | This is the | Simple | Drop | Thermal ink |
| directly | simplest mode of | operation | repetition rate is | jet |
| pushes | operation: the | No external | usually limited | Piezoelectric |
| ink | actuator directly | fields required | to around 10 kHz. | ink jet |
| | supplies sufficient | Satellite drops | However, | IJ01, IJ02, |
| | kinetic energy to | can be avoided if | this is not | IJ03, IJ04, IJ05, |
| | expel the drop. | drop velocity is | fundamental to | IJ06, IJ07, IJ09, |
| | The drop must | less than 4 m/s | the method, but | IJ11, IJ12, IJ14, |
| | have a sufficient | Can be | is related to the | IJ16, IJ20, IJ22, |
| | velocity to | efficient, | refill method | IJ23, IJ24, IJ25, |
| | overcome the | depending upon | normally used | IJ26, IJ27, IJ28, |
| | surface tension. | the actuator used | All of the drop | IJ29, IJ30, IJ31, |
| | | | kinetic energy | IJ32, IJ33, IJ34, |
| | | | must be | IJ35, IJ36, IJ37, |
| | | | provided by the | IJ38, IJ39, IJ40, |
| | | | actuator | IJ41, IJ42, IJ43, |
| | | | Satellite drops | IJ44 |
| | | | usually form if | |
| | | | drop velocity is | |
| | | | greater than 4.5 m/s | |
| Proximity | The drops to be | Very simple | Requires close | Silverbrook, |
| | printed are | print head | proximity | EP 0771 658 A2 |
| | selected by some | fabrication can | between the | and related |
| | manner (e.g. | be used | print head and | patent |
| | thermally induced | The drop | the print media | applications |
| | surface tension | selection means | or transfer roller | |
| | reduction of | does not need to | May require | |
| | pressurized ink). | provide the | two print heads | |
| | Selected drops are | energy required | printing alternate | |
| | separated from the | to separate the | rows of the | |
| | ink in the nozzle | drop from the | image | |
| | by contact with the | nozzle | Monolithic | |
| | print medium or a | | color print heads | |
| | transfer roller. | | are difficult | |
| Electro- | The drops to be | Very simple | Requires very | Silverbrook, |
| static pull | printed are | print head | high electrostatic | EP 0771 658 A2 |
| on ink | selected by some | fabrication can | field | and related |
| | manner (e.g. | be used | Electrostatic | patent |
| | thermally induced | The drop | field for small | applications |
| | surface tension | selection means | nozzle sizes is | Tone-Jet |
| | reduction of | does not need to | above air | |
| | pressurized ink). | provide the | breakdown | |
| | Selected drops are | energy required | Electrostatic | |
| | separated from the | to separate the | field may attract | |
| | ink in the nozzle | drop from the | dust | |
| | by a strong electric | nozzle | | |
| | field. | | | |
| Magnetic | The drops to be | Very simple | Requires | Silverbrook, |
| pull on | printed are | print head | magnetic ink | EP 0771 658 A2 |
| ink | selected by some | fabrication can | Ink colors | and related |
| | manner (e.g. | be used | other than black | patent |
| | thermally induced | The drop | are difficult | applications |
| | surface tension | selection means | Requires very | |
| | reduction of | does not need to | high magnetic | |
| | pressurized ink). | provide the | fields | |
| | Selected drops are | energy required | | |
| | separated from the | to separate the | | |
| | ink in the nozzle | drop from the | | |
| | by a strong | nozzle | | |
| | magnetic field | | | |
| | acting on the | | | |
| | magnetic ink. | | | |
| Shutter | The actuator | High speed | Moving parts | IJ13, IJ17, |
| | moves a shutter to | (>50 kHz) | are required | IJ21 |
| | block ink flow to | operation can be | Requires ink | |
| | the nozzle. The ink | achieved due to | pressure | |
| | pressure is pulsed | reduced refill | modulator | |
| | at a multiple of the | time | Friction and | |
| | drop ejection | Drop timing | wear must be | |
| | frequency. | can be very | considered | |
| | | accurate | Stiction is | |
| | | The actuator | possible | |
| | | energy can be | | |
| | | very low | | |
| Shuttered | The actuator | Actuators with | Moving parts | IJ08, IJ15, |
| grill | moves a shutter to | small travel can | are required | IJ18, IJ19 |
| | block ink flow | be used | Requires ink | |
| | through a grill to | Actuators with | pressure | |
| | the nozzle. The | small force can | modulator | |
| | shutter movement | be used | Friction and | |
| | need only be equal | High speed | wear must be | |
| | to the width of the | (>50 kHz) | considered | |
| | grill holes. | operation can be | Stiction is | |
| | | achieved | possible | |
| Pulsed | A pulsed magnetic | Extremely low | Requires an | IJ10 |
| magnetic | field attracts an | energy operation | external pulsed | |
| pull on | ‘ink pusher’ at the | is possible | magnetic field | |
| ink | drop ejection | No heat | Requires | |
| pusher | frequency. An | dissipation | special materials | |
| | actuator controls a | problems | for both the | |
| | catch, which | | actuator and the | |
| | prevents the ink | | ink pusher | |
| | pusher from | | Complex | |
| | moving when a | | construction | |
| | drop is not to be | | | |
| | ejected. | | | |

AUXILIARY MECHANISM (APPLIED TO ALL NOZZLES)

| | | | | |
|---|---|---|---|---|
| None | The actuator | Simplicity of | Drop ejection | Most ink jets, |
| | directly fires the | construction | energy must be | including |
| | ink drop, and there | Simplicity of | supplied by | piezoelectric and |
| | is no external field | operation | individual nozzle | thermal bubble. |
| | or other | Small physical | actuator | IJ01, IJ02, |
| | mechanism | size | | IJ03, IJ04, IJ05, |
| | required. | | | IJ07, IJ09, IJ11, |
| | | | | IJ12, IJ14, IJ20, |
| | | | | IJ22, IJ23, IJ24, |
| | | | | IJ25, IJ26, IJ27, |
| | | | | IJ28, IJ29, IJ30, |
| | | | | IJ31, IJ32, IJ33, |
| | | | | IJ34, IJ35, IJ36, |
| | | | | IJ37, IJ38, IJ39, |
| | | | | IJ40, IJ41, IJ42, |
| | | | | IJ43, IJ44 |

BASIC OPERATION MODE

| | | | | |
|---|---|---|---|---|
| Oscillating | The ink pressure | Oscillating ink | Requires | Silverbrook, |
| ink | oscillates, | pressure can | external ink | EP 0771 658 A2 |
| pressure | providing much of | provide a refill | pressure | and related |
| (including | the drop ejection | pulse, allowing | oscillator | patent |
| acoustic | energy. The | higher operating | Ink pressure | applications |
| stimulation) | actuator selects | speed | phase and | IJ08, IJ13, |
| | which drops are to | The actuators | amplitude must | IJ15, IJ17, IJ18, |
| | be fired by | may operate | be carefully | IJ19, IJ21 |
| | selectively | with much lower | controlled | |
| | blocking or | energy | Acoustic | |
| | enabling nozzles. | Acoustic | reflections in the | |
| | The ink pressure | lenses can be | ink chamber | |
| | oscillation may be | used to focus the | must be | |
| | achieved by | sound on the | designed for | |
| | vibrating the print | nozzles | | |
| | head, or preferably | | | |
| | by an actuator in | | | |
| | the ink supply. | | | |
| Media | The print head is | Low power | Precision | Silverbrook, |
| proximity | placed in close | High accuracy | assembly | EP 0771 658 A2 |
| | proximity to the | Simple print | required | and related |
| | print medium. | head | Paper fibers | patent |
| | Selected drops | construction | may cause | applications |
| | protrude from the | | problems | |
| | print head further | | Cannot print | |
| | than unselected | | on rough | |
| | drops, and contact | | substrates | |
| | the print medium. | | | |
| | The drop soaks | | | |
| | into the medium | | | |
| | fast enough to | | | |
| | cause drop | | | |
| | separation. | | | |
| Transfer | Drops are printed | High accuracy | Bulky | Silverbrook, |
| roller | to a transfer roller | Wide range of | Expensive | EP 0771 658 A2 |
| | instead of straight | print substrates | Complex | and related |
| | to the print | can be used | construction | patent |
| | medium. A | Ink can be | | applications |
| | transfer roller can | dried on the | | Tektronix hot |
| | also be used for | transfer roller | | melt |
| | proximity drop | | | piezoelectric ink |
| | separation. | | | jet |
| | | | | Any of the IJ |
| | | | | series |
| Electro- | An electric field is | Low power | Field strength | Silverbrook, |
| static | used to accelerate | Simple print | required for | EP 0771 658 A2 |
| | selected drops | head | separation of | and related |
| | towards the print | construction | small drops is | patent |
| | medium. | | near or above air | applications |
| | | | breakdown | Tone-Jet |
| Direct | A magnetic field is | Low power | Requires | Silverbrook, |
| magnetic | used to accelerate | Simple print | magnetic ink | EP 0771 658 A2 |
| field | selected drops of | head | Requires | and related |
| | magnetic ink | construction | strong magnetic | patent |
| | towards the print | | field | applications |
| | medium. | | | |
| Cross | The print head is | Does not | Requires | IJ06, IJ16 |
| magnetic | placed in a | require magnetic | external magnet | |
| field | constant magnetic | materials to be | Current | |
| | field. The Lorenz | integrated in the | densities may be | |
| | force in a current | print head | high, resulting in | |
| | carrying wire is | manufacturing | electromigration | |
| | used to move the | process | problems | |
| | actuator. | | | |
| Pulsed | A pulsed magnetic | Very low | Complex print | IJ10 |
| magnetic | field is used to | power operation | head | |
| field | cyclically attract a | is possible | construction | |
| | paddle, which | Small print | Magnetic | |
| | pushes on the ink. | head size | materials | |
| | A small actuator | | required in print | |
| | moves a catch, | | head | |
| | which selectively | | | |
| | prevents the | | | |
| | paddle from | | | |
| | moving. | | | |

ACTUATOR AMPLIFICATION OR MODIFICATION METHOD

| | Description | Advantages | Disadvantages | Examples |
|---|---|---|---|---|
| None | No actuator | Operational | Many actuator | Thermal |
| | mechanical | simplicity | mechanisms | Bubble Ink jet |
| | amplification is | | have insufficient | IJ01, IJ02, |
| | used. The actuator | | travel, or | IJ06, IJ07, IJ16, |
| | directly drives the | | insufficient | IJ25, IJ26 |
| | drop ejection | | force, to | |
| | process. | | efficiently drive | |
| | | | the drop ejection | |
| | | | process | |
| Differential | An actuator | Provides | High stresses | Piezoelectric |
| expansion | material expands | greater travel in | are involved | IJ03, IJ09, |
| bend | more on one side | a reduced print | Care must be | IJ17, IJ18, IJ19, |
| actuator | than on the other. | head area | taken that the | IJ20, IJ21, IJ22, |
| | The expansion | | materials do not | IJ23, IJ24, IJ27, |
| | may be thermal, | | delaminate | IJ29, IJ30, IJ31, |
| | piezoelectric, | | Residual bend | IJ32, IJ33, IJ34, |
| | magnetostrictive, | | resulting from | IJ35, IJ36, IJ37, |
| | or other | | high temperature | IJ38, IJ39, IJ42, |
| | mechanism. The | | or high stress | IJ43, IJ44 |
| | bend actuator | | during formation | |
| | converts a high | | | |
| | force low travel | | | |
| | actuator | | | |
| | mechanism to high | | | |
| | travel, lower force | | | |
| | mechanism. | | | |
| Transient | A trilayer bend | Very good | High stresses | IJ40, IJ41 |
| bend | actuator where the | temperature | are involved | |
| actuator | two outside layers | stability | Care must be | |
| | are identical. This | High speed, as | taken that the | |
| | cancels bend due | a new drop can | materials do not | |
| | to ambient | be fired before | delaminate | |
| | temperature and | heat dissipates | | |
| | residual stress. The | Cancels | | |
| | actuator only | residual stress of | | |
| | responds to | formation | | |
| | transient heating of | | | |
| | one side or the | | | |
| | other. | | | |
| Reverse | The actuator loads | Better | Fabrication | IJ05, IJ11 |
| spring | a spring. When the | coupling to the | complexity | |
| | actuator is turned | ink | High stress in | |
| | off, the spring | | the spring | |
| | releases. This can | | | |
| | reverse the | | | |
| | force/distance | | | |
| | curve of the | | | |
| | actuator to make it | | | |
| | compatible with | | | |
| | the force/time | | | |
| | requirements of | | | |
| | the drop ejection. | | | |
| Actuator | A series of thin | Increased | Increased | Some |
| stack | actuators are | travel | fabrication | piezoelectric ink |
| | stacked. This can | Reduced drive | complexity | jets |
| | be appropriate | voltage | Increased | IJ04 |
| | where actuators | | possibility of | |
| | require high | | short circuits due | |
| | electric field | | to pinholes | |
| | strength, such as | | | |
| | electrostatic and | | | |
| | piezoelectric | | | |
| | actuators. | | | |
| Multiple | Multiple smaller | Increases the | Actuator | IJ12, IJ13, |
| actuators | actuators are used | force available | forces may not | IJ18, IJ20, IJ22, |
| | simultaneously to | from an actuator | add linearly, | IJ28, IJ42, IJ43 |
| | move the ink. Each | Multiple | reducing | |
| | actuator need | actuators can be | efficiency | |
| | provide only a | positioned to | | |
| | portion of the | control ink flow | | |
| | force required. | accurately | | |
| Linear | A linear spring is | Matches low | Requires print | IJ15 |
| Spring | used to transform a | travel actuator | head area for the | |
| | motion with small | with higher | spring | |
| | travel and high | travel | | |
| | force into a longer | requirements | | |
| | travel, lower force | Non-contact | | |
| | motion. | method of | | |
| | | motion | | |
| | | transformation | | |
| Coiled | A bend actuator is | Increases | Generally | IJ17, IJ21, |
| actuator | coiled to provide | travel | restricted to | IJ34, IJ35 |
| | greater travel in a | Reduces chip | planar | |
| | reduced chip area. | area | implementations | |
| | | Planar | due to extreme | |
| | | implementations | fabrication | |
| | | are relatively | difficulty in | |
| | | easy to fabricate. | other | |
| | | | orientations. | |
| Flexure | A bend actuator | Simple means | Care must be | IJ10, IJ19, |
| bend | has a small region | of increasing | taken not to | IJ33 |
| actuator | near the fixture | travel of a bend | exceed the | |
| | point, which flexes | actuator | elastic limit in | |
| | much more readily | | the flexure area | |
| | than the remainder | | Stress | |
| | of the actuator. | | distribution is | |
| | The actuator | | very uneven | |
| | flexing is | | Difficult to | |
| | effectively | | accurately model | |
| | converted from an | | with finite | |
| | even coiling to an | | element analysis | |
| | angular bend, | | | |
| | resulting in greater | | | |
| | travel of the | | | |
| | actuator tip. | | | |
| Catch | The actuator | Very low | Complex | IJ10 |
| | controls a small | actuator energy | construction | |
| | catch. The catch | Very small | Requires | |
| | either enables or | actuator size | external force | |
| | disables movement | | Unsuitable for | |
| | of an ink pusher | | pigmented inks | |
| | that is controlled | | | |
| | in a bulk manner. | | | |
| Gears | Gears can be used | Low force, | Moving parts | IJ13 |
| | to increase travel | low travel | are required | |
| | at the expense of | actuators can be | Several | |
| | duration. Circular | used | actuator cycles | |
| | gears, rack and | Can be | are required | |
| | pinion, ratchets, | fabricated using | More complex | |
| | and other gearing | standard surface | drive electronics | |
| | methods can be | MEMS | Complex | |
| | used. | processes | construction | |
| | | | Friction, | |
| | | | friction, and | |
| | | | wear are | |
| | | | possible | |
| Buckle | A buckle plate can | Very fast | Must stay | S. Hirata et al, |
| plate | be used to change | movement | within elastic | “An Ink-jet |
| | a slow actuator | achievable | limits of the | Head Using |
| | into a fast motion. | | materials for | Diaphragm |
| | It can also convert | | long device life | Microactuator”, |
| | a high force, low | | High stresses | Proc. IEEE |
| | travel actuator into | | involved | MEMS, February |
| | a high travel, | | Generally | 1996, pp 418-423. |
| | medium force | | high power | IJ18, IJ27 |
| | motion. | | requirement | |
| Tapered | A tapered | Linearizes the | Complex | IJ14 |
| magnetic | magnetic pole can | magnetic | construction | |
| pole | increase travel at | force/distance | | |
| | the expense of | curve | | |
| | force. | | | |
| Lever | A lever and | Matches low | High stress | IJ32, IJ36, |
| | fulcrum is used to | travel actuator | around the | IJ37 |
| | transform a motion | with higher | fulcrum | |
| | with small travel | travel | | |
| | and high force into | requirements | | |
| | a motion with | Fulcrum area | | |
| | longer travel and | has no linear | | |
| | lower force. The | movement, and | | |
| | lever can also | can be used for a | | |
| | reverse the | fluid seal | | |
| | direction of travel. | | | |
| Rotary | The actuator is | High | Complex | IJ28 |
| impeller | connected to a | mechanical | construction | |
| | rotary impeller. A | advantage | Unsuitable for | |
| | small angular | The ratio of | pigmented inks | |
| | deflection of the | force to travel of | | |
| | actuator results in | the actuator can | | |
| | a rotation of the | be matched to | | |
| | impeller vanes, | the nozzle | | |
| | which push the ink | requirements by | | |
| | against stationary | varying the | | |
| | vanes and out of | number of | | |
| | the nozzle. | impeller vanes | | |
| Acoustic | A refractive or | No moving | Large area | 1993 |
| lens | diffractive (e.g. | parts | required | Hadimioglu et |
| | zone plate) | | Only relevant | al, EUP 550,192 |
| | acoustic lens is | | for acoustic ink | 1993 Elrod et |
| | used to concentrate | | jets | al, EUP 572,220 |
| | sound waves. | | | |
| Sharp | A sharp point is | Simple | Difficult to | Tone-jet |
| conductive | used to concentrate | construction | fabricate using | |
| point | an electrostatic | | standard VLSI | |
| | field. | | processes for a | |
| | | | surface ejecting | |
| | | | ink-jet | |
| | | | Only relevant | |
| | | | for electrostatic | |
| | | | ink jets | |

ACTUATOR MOTION

| | Description | Advantages | Disadvantages | Examples |
|---|---|---|---|---|
| Volume | The volume of the | Simple | High energy is | Hewlett- |
| expansion | actuator changes, | construction in | typically | Packard Thermal |
| | pushing the ink in | the case of | required to | Ink jet |
| | all directions. | thermal ink jet | achieve volume | Canon |
| | | | expansion. This | Bubblejet |
| | | | leads to thermal | |
| | | | stress, cavitation, | |
| | | | and kogation in | |
| | | | thermal ink jet | |
| | | | implementations | |
| Linear, | The actuator | Efficient | High | IJ01, IJ02, |
| normal to | moves in a | coupling to ink | fabrication | IJ04, IJ07, IJ11, |
| chip | direction normal to | drops ejected | complexity may | IJ14 |
| surface | the print head | normal to the | be required to | |
| | surface. The | surface | achieve | |
| | nozzle is typically | | perpendicular | |
| | in the line of | | motion | |
| | movement. | | | |
| Parallel to | The actuator | Suitable for | Fabrication | IJ12, IJ13, |
| chip | moves parallel to | planar | complexity | IJ15, IJ33,, IJ34, |
| surface | the print head | fabrication | Friction | IJ35, IJ36 |
| | surface. Drop | | Stiction | |
| | ejection may still | | | |
| | be normal to the | | | |
| | surface. | | | |
| Membrane | An actuator with a | The effective | Fabrication | 1982 Howkins |
| push | high force but | area of the | complexity | U.S. Pat. No. 4,459,601 |
| | small area is used | actuator | Actuator size | |
| | to push a stiff | becomes the | Difficulty of | |
| | membrane that is | membrane area | integration in a | |
| | in contact with the | | VLSI process | |
| | ink. | | | |
| Rotary | The actuator | Rotary levers | Device | IJ05, IJ08, |
| | causes the rotation | may be used to | complexity | IJ13, IJ28 |
| | of some element, | increase travel | May have | |
| | such a grill or | Small chip | friction at a pivot | |
| | impeller | area | point | |
| | | requirements | | |
| Bend | The actuator bends | A very small | Requires the | 1970 Kyser et |
| | when energized. | change in | actuator to be | al U.S. Pat. No. |
| | This may be due to | dimensions can | made from at | 3,946,398 |
| | differential | be converted to a | least two distinct | 1973 Stemme |
| | thermal expansion, | large motion. | layers, or to have | U.S. Pat. No. 3,747,120 |
| | piezoelectric | | a thermal | IJ03, IJ09, |
| | expansion, | | difference across | IJ10, IJ19, IJ23, |
| | magnetostriction, | | the actuator | IJ24, IJ25, IJ29, |
| | or other form of | | | IJ30, IJ31, IJ33, |
| | relative | | | IJ34, IJ35 |
| | dimensional | | | |
| | change. | | | |
| Swivel | The actuator | Allows | Inefficient | IJ06 |
| | swivels around a | operation where | coupling to the | |
| | central pivot. This | the net linear | ink motion | |
| | motion is suitable | force on the | | |
| | where there are | paddle is zero | | |
| | opposite forces | Small chip | | |
| | applied to opposite | area | | |
| | sides of the paddle, | requirements | | |
| | e.g. Lorenz force. | | | |
| Straighten | The actuator is | Can be used | Requires | IJ26, IJ32 |
| | normally bent, and | with shape | careful balance | |
| | straightens when | memory alloys | of stresses to | |
| | energized. | where the | ensure that the | |
| | | austenic phase is | quiescent bend is | |
| | | planar | accurate | |
| Double | The actuator bends | One actuator | Difficult to | IJ36, IJ37, |
| bend | in one direction | can be used to | make the drops | IJ38 |
| | when one element | power two | ejected by both | |
| | is energized, and | nozzles. | bend directions | |
| | bends the other | Reduced chip | identical. | |
| | way when another | size. | A small | |
| | element is | Not sensitive | efficiency loss | |
| | energized. | to ambient | compared to | |
| | | temperature | equivalent single | |
| | | | bend actuators. | |
| Shear | Energizing the | Can increase | Not readily | 1985 Fishbeck |
| | actuator causes a | the effective | applicable to | U.S. Pat. No. 4,584,590 |
| | shear motion in the | travel of | other actuator | |
| | actuator material. | piezoelectric | mechanisms | |
| | | actuators | | |
| Radial | The actuator | Relatively | High force | 1970 Zoltan |
| constriction | squeezes an ink | easy to fabricate | required | U.S. Pat. No. 3,683,212 |
| | reservoir, forcing | single nozzles | Inefficient | |
| | ink from a | from glass | Difficult to | |
| | constricted nozzle. | tubing as | integrate with | |
| | | macroscopic | VLSI processes | |
| | | structures | | |
| Coil/ | A coiled actuator | Easy to | Difficult to | IJ17, IJ21, |
| uncoil | uncoils or coils | fabricate as a | fabricate for | IJ34, IJ35 |
| | more tightly. The | planar VLSI | non-planar | |
| | motion of the free | process | devices | |
| | end of the actuator | Small area | Poor out-of- | |
| | ejects the ink. | required, | plane stiffness | |
| | | therefore low | | |
| | | cost | | |
| Bow | The actuator bows | Can increase | Maximum | IJ16, IJ18, |
| | (or buckles) in the | the speed of | travel is | IJ27 |
| | middle when | travel | constrained | |
| | energized. | Mechanically | High force | |
| | | rigid | required | |
| Push-Pull | Two actuators | The structure | Not readily | IJ18 |
| | control a shutter. | is pinned at both | suitable for ink | |
| | One actuator pulls | ends, so has a | jets which | |
| | the shutter, and the | high out-of- | directly push the | |
| | other pushes it. | plane rigidity | ink | |
| Curl | A set of actuators | Good fluid | Design | IJ20, IJ42 |
| inwards | curl inwards to | flow to the | complexity | |
| | reduce the volume | region behind | | |
| | of ink that they | the actuator | | |
| | enclose. | increases | | |
| | | efficiency | | |
| Curl | A set of actuators | Relatively | Relatively | IJ43 |
| outwards | curl outwards, | simple | large chip area | |
| | pressurizing ink in | construction | | |
| | a chamber | | | |
| | surrounding the | | | |
| | actuators, and | | | |
| | expelling ink from | | | |
| | a nozzle in the | | | |
| | chamber. | | | |
| Iris | Multiple vanes | High | High | IJ22 |
| | enclose a volume | efficiency | fabrication | |
| | of ink. These | Small chip | complexity | |
| | simultaneously | area | Not suitable | |
| | rotate, reducing | | for pigmented | |
| | the volume | | inks | |
| | between the vanes. | | | |
| Acoustic | The actuator | The actuator | Large area | 1993 |
| vibration | vibrates at a high | can be | required for | Hadimioglu et |
| | frequency. | physically | efficient | al, EUP 550,192 |
| | | distant from the | operation at | 1993 Elrod et |
| | | ink | useful | al, EUP 572,220 |
| | | | frequencies | |
| | | | Acoustic | |
| | | | coupling and | |
| | | | crosstalk | |
| | | | Complex | |
| | | | drive circuitry | |
| | | | Poor control | |
| | | | of drop volume | |
| | | | and position | |
| None | In various ink jet | No moving | Various other | Silverbrook, |
| | designs the | parts | tradeoffs are | EP 0771 658 A2 |
| | actuator does not | | required to | and related |
| | move. | | eliminate | patent |
| | | | moving parts | applications |
| | | | | Tone-jet |

NOZZLE REFILL METHOD

| | Description | Advantages | Disadvantages | Examples |
|---|---|---|---|---|
| Surface | This is the normal | Fabrication | Low speed | Thermal ink |
| tension | way that ink jets | simplicity | Surface | jet |
| | are refilled. After | Operational | tension force | Piezoelectric |
| | the actuator is | simplicity | relatively small | ink jet |
| | energized, it | | compared to | IJ01-IJ07, |
| | typically returns | | actuator force | IJ10-IJ14, IJ16, |
| | rapidly to its | | Long refill | IJ20, IJ22-IJ45 |
| | normal position. | | time usually | |
| | This rapid return | | dominates the | |
| | sucks in air | | total repetition | |
| | through the nozzle | | rate | |
| | opening. The ink | | | |
| | surface tension at | | | |
| | the nozzle then | | | |
| | exerts a small | | | |
| | force restoring the | | | |
| | meniscus to a | | | |
| | minimum area. | | | |
| | This force refills | | | |
| | the nozzle. | | | |
| Shuttered | Ink to the nozzle | High speed | Requires | IJ08, IJ13, |
| oscillating | chamber is | Low actuator | common ink | IJ15, IJ17, IJ18, |
| ink | provided at a | energy, as the | pressure | IJ19, IJ21 |
| pressure | pressure that | actuator need | oscillator | |
| | oscillates at twice | only open or | May not be | |
| | the drop ejection | close the shutter, | suitable for | |
| | frequency. When a | instead of | pigmented inks | |
| | drop is to be | ejecting the ink | | |
| | ejected, the shutter | drop | | |
| | is opened for 3 | | | |
| | half cycles: drop | | | |
| | ejection, actuator | | | |
| | return, and refill. | | | |
| | The shutter is then | | | |
| | closed to prevent | | | |
| | the nozzle | | | |
| | chamber emptying | | | |
| | during the next | | | |
| | negative pressure | | | |
| | cycle. | | | |
| Refill | After the main | High speed, as | Requires two | IJ09 |
| actuator | actuator has | the nozzle is | independent | |
| | ejected a drop a | actively refilled | actuators per | |
| | second (refill) | | nozzle | |
| | actuator is | | | |
| | energized. The | | | |
| | refill actuator | | | |
| | pushes ink into the | | | |
| | nozzle chamber. | | | |
| | The refill actuator | | | |
| | returns slowly, to | | | |
| | prevent its return | | | |
| | from emptying the | | | |
| | chamber again. | | | |
| Positive | The ink is held a | High refill | Surface spill | Silverbrook, |
| ink | slight positive | rate, therefore a | must be | EP 0771 658 A2 |
| pressure | pressure. After the | high drop | prevented | and related |
| | ink drop is ejected, | repetition rate is | Highly | patent |
| | the nozzle | possible | hydrophobic | applications |
| | chamber fills | | print head | Alternative |
| | quickly as surface | | surfaces are | for:, IJ01-IJ07, |
| | tension and ink | | required | IJ10-IJ14, IJ16, |
| | pressure both | | | IJ20, IJ22-IJ45 |
| | operate to refill the | | | |
| | nozzle. | | | |

METHOD OF RESTRICTING BACK-FLOW THROUGH INLET

| | Description | Advantages | Disadvantages | Examples |
|---|---|---|---|---|
| Long inlet | The ink inlet | Design | Restricts refill | Thermal ink |
| channel | channel to the | simplicity | rate | jet |
| | nozzle chamber is | Operational | May result in | Piezoelectric |
| | made long and | simplicity | a relatively large | ink jet |
| | relatively narrow, | Reduces | chip area | IJ42, IJ43 |
| | relying on viscous | crosstalk | Only partially | |
| | drag to reduce | | effective | |
| | inlet back-flow. | | | |
| Positive | The ink is under a | Drop selection | Requires a | Silverbrook, |
| ink | positive pressure, | and separation | method (such as | EP 0771 658 A2 |
| pressure | so that in the | forces can be | a nozzle rim or | and related |
| | quiescent state | reduced | effective | patent |
| | some of the ink | Fast refill time | hydrophobizing, | applications |
| | drop already | | or both) to | Possible |
| | protrudes from the | | prevent flooding | operation of the |
| | nozzle. | | of the ejection | following: IJ01-IJ07, |
| | This reduces the | | surface of the | IJ09-IJ12, |
| | pressure in the | | print head. | IJ14, IJ16, IJ20, |
| | nozzle chamber | | | IJ22,, IJ23-IJ34, |
| | which is required | | | IJ36-IJ41, IJ44 |
| | to eject a certain | | | |
| | volume of ink. The | | | |
| | reduction in | | | |
| | chamber pressure | | | |
| | results in a | | | |
| | reduction in ink | | | |
| | pushed out through | | | |
| | the inlet. | | | |
| Baffle | One or more | The refill rate | Design | HP Thermal |
| | baffles are placed | is not as | complexity | Ink Jet |
| | in the inlet ink | restricted as the | May increase | Tektronix |
| | flow. When the | long inlet | fabrication | piezoelectric ink |
| | actuator is | method. | complexity (e.g. | jet |
| | energized, the | Reduces | Tektronix hot | |
| | rapid ink | crosstalk | melt | |
| | movement creates | | Piezoelectric | |
| | eddies which | | print heads). | |
| | restrict the flow | | | |
| | through the inlet. | | | |
| | The slower refill | | | |
| | process is | | | |
| | unrestricted, and | | | |
| | does not result in | | | |
| | eddies. | | | |
| Flexible | In this method | Significantly | Not applicable | Canon |
| flap | recently disclosed | reduces back- | to most ink jet | |
| restricts | by Canon, the | flow for edge- | configurations | |
| inlet | expanding actuator | shooter thermal | Increased | |
| | (bubble) pushes on | ink jet devices | fabrication | |
| | a flexible flap that | | complexity | |
| | restricts the inlet. | | Inelastic | |
| | | | deformation of | |
| | | | polymer flap | |
| | | | results in creep | |
| | | | over extended | |
| | | | use | |
| Inlet filter | A filter is located | Additional | Restricts refill | IJ04, IJ12, |
| | between the ink | advantage of ink | rate | IJ24, IJ27, IJ29, |
| | inlet and the | filtration | May result in | IJ30 |
| | nozzle chamber. | Ink filter may | complex | |
| | The filter has a | be fabricated | construction | |
| | multitude of small | with no | | |
| | holes or slots, | additional | | |
| | restricting ink | process steps | | |
| | flow. The filter | | | |
| | also removes | | | |
| | particles which | | | |
| | may block the | | | |
| | nozzle. | | | |
| Small | The ink inlet | Design | Restricts refill | IJ02, IJ37, |
| inlet | channel to the | simplicity | rate | IJ44 |
| compared | nozzle chamber | | May result in | |
| to nozzle | has a substantially | | a relatively large | |
| | smaller cross | | chip area | |
| | section than that of | | Only partially | |
| | the nozzle, | | effective | |
| | resulting in easier | | | |
| | ink egress out of | | | |
| | the nozzle than out | | | |
| | of the inlet. | | | |
| Inlet | A secondary | Increases | Requires | IJ09 |
| shutter | actuator controls | speed of the ink- | separate refill | |
| | the position of a | jet print head | actuator and | |
| | shutter, closing off | operation | drive circuit | |
| | the ink inlet when | | | |
| | the main actuator | | | |
| | is energized. | | | |
| The inlet | The method avoids | Back-flow | Requires | IJ01, IJ03, |
| is located | the problem of | problem is | careful design to | IJ05, IJ06, IJ07, |
| behind | inlet back-flow by | eliminated | minimize the | IJ10, IJ11, IJ14, |
| the ink- | arranging the ink- | | negative | IJ16, IJ22, IJ23, |
| pushing | pushing surface of | | pressure behind | IJ25, IJ28, IJ31, |
| surface | the actuator | | the paddle | IJ32, IJ33, IJ34, |
| | between the inlet | | | IJ35, IJ36, IJ39, |
| | and the nozzle. | | | IJ40, IJ41 |
| Part of | The actuator and a | Significant | Small increase | IJ07, IJ20, |
| the | wall of the ink | reductions in | in fabrication | IJ26, IJ38 |
| actuator | chamber are | back-flow can be | complexity | |
| moves to | arranged so that | achieved | | |
| shut off | the motion of the | Compact | | |
| the inlet | actuator closes off | designs possible | | |
| | the inlet. | | | |
| Nozzle | In some | Ink back-flow | None related | Silverbrook, |
| actuator | configurations of | problem is | to ink back-flow | EP 0771 658 A2 |
| does not | ink jet, there is no | eliminated | on actuation | and related |
| result in | expansion or | | | patent |
| ink back- | movement of an | | | applications |
| flow | actuator which | | | Valve-jet |
| | may cause ink | | | Tone-jet |
| | back-flow through | | | |
| | the inlet. | | | |

NOZZLE CLEARING METHOD

| | Description | Advantages | Disadvantages | Examples |
|---|---|---|---|---|
| Normal | All of the nozzles | No added | May not be | Most ink jet |
| nozzle | are fired | complexity on | sufficient to | systems |
| firing | periodically, | the print head | displace dried | IJ01, IJ02, |
| | before the ink has | | ink | IJ03, IJ04, IJ05, |
| | a chance to dry. | | | IJ06, IJ07, IJ09, |
| | When not in use | | | IJ10, IJ11, IJ12, |
| | the nozzles are | | | IJ14, IJ16, IJ20, |
| | sealed (capped) | | | IJ22, IJ23, IJ24, |
| | against air. | | | IJ25, IJ26, IJ27, |
| | The nozzle firing | | | IJ28, IJ29, IJ30, |
| | is usually | | | IJ31, IJ32, IJ33, |
| | performed during a | | | IJ34, IJ36, IJ37, |
| | special clearing | | | IJ38, IJ39, IJ40,, |
| | cycle, after first | | | IJ41, IJ42, IJ43, |
| | moving the print | | | IJ44,, IJ45 |
| | head to a cleaning | | | |
| | station. | | | |
| Extra | In systems which | Can be highly | Requires | Silverbrook, |
| power to | heat the ink, but do | effective if the | higher drive | EP 0771 658 A2 |
| ink heater | not boil it under | heater is | voltage for | and related |
| | normal situations, | adjacent to the | clearing | patent |
| | nozzle clearing can | nozzle | May require | applications |
| | be achieved by | | larger drive | |
| | over-powering the | | transistors | |
| | heater and boiling | | | |
| | ink at the nozzle. | | | |
| Rapid | The actuator is | Does not | Effectiveness | May be used |
| succession | fired in rapid | require extra | depends | with: IJ01, IJ02, |
| of | succession. In | drive circuits on | substantially | IJ03, IJ04, IJ05, |
| actuator | some | the print head | upon the | IJ06, IJ07, IJ09, |
| pulses | configurations, this | Can be readily | configuration of | IJ10, IJ11, IJ14, |
| | may cause heat | controlled and | the ink jet nozzle | IJ16, IJ20, IJ22, |
| | build-up at the | initiated by | | IJ23, IJ24, IJ25, |
| | nozzle which boils | digital logic | | IJ27, IJ28, IJ29, |
| | the ink, clearing | | | IJ30, IJ31, IJ32, |
| | the nozzle. In other | | | IJ33, IJ34, IJ36, |
| | situations, it may | | | IJ37, IJ38, IJ39, |
| | cause sufficient | | | IJ40, IJ41, IJ42, |
| | vibrations to | | | IJ43, IJ44, IJ45 |
| | dislodge clogged | | | |
| | nozzles. | | | |
| Extra | Where an actuator | A simple | Not suitable | May be used |
| power to | is not normally | solution where | where there is a | with: IJ03, IJ09, |
| ink | driven to the limit | applicable | hard limit to | IJ16, IJ20, IJ23, |
| pushing | of its motion, | | actuator | IJ24, IJ25, IJ27, |
| actuator | nozzle clearing | | movement | IJ29, IJ30, IJ31, |
| | may be assisted by | | | IJ32, IJ39, IJ40, |
| | providing an | | | IJ41, IJ42, IJ43, |
| | enhanced drive | | | IJ44, IJ45 |
| | signal to the | | | |
| | actuator. | | | |
| Acoustic | An ultrasonic | A high nozzle | High | IJ08, IJ13, |
| resonance | wave is applied to | clearing | implementation | IJ15, IJ17, IJ18, |
| | the ink chamber. | capability can be | cost if system | IJ19, IJ21 |
| | This wave is of an | achieved | does not already | |
| | appropriate | May be | include an | |
| | amplitude and | implemented at | acoustic actuator | |
| | frequency to cause | very low cost in | | |
| | sufficient force at | systems which | | |
| | the nozzle to clear | already include | | |
| | blockages. This is | acoustic | | |
| | easiest to achieve | actuators | | |
| | if the ultrasonic | | | |
| | wave is at a | | | |
| | resonant frequency | | | |
| | of the ink cavity. | | | |
| Nozzle | A microfabricated | Can clear | Accurate | Silverbrook, |
| clearing | plate is pushed | severely clogged | mechanical | EP 0771 658 A2 |
| plate | against the | nozzles | alignment is | and related |
| | nozzles. The plate | | required | patent |
| | has a post for | | Moving parts | applications |
| | every nozzle. A | | are required | |
| | post moves | | There is risk | |
| | through each | | of damage to the | |
| | nozzle, displacing | | nozzles | |
| | dried ink. | | Accurate | |
| | | | fabrication is | |
| | | | required | |
| Ink | The pressure of the | May be | Requires | May be used |
| pressure | ink is temporarily | effective where | pressure pump | with all IJ series |
| pulse | increased so that | other methods | or other pressure | ink jets |
| | ink streams from | cannot be used | actuator | |
| | all of the nozzles. | | Expensive | |
| | This may be used | | Wasteful of | |
| | in conjunction | | ink | |
| | with actuator | | | |
| | energizing. | | | |
| Print | A flexible ‘blade’ | Effective for | Difficult to | Many ink jet |
| head | is wiped across the | planar print head | use if print head | systems |
| wiper | print head surface. | surfaces | surface is non- | |
| | The blade is | Low cost | planar or very | |
| | usually fabricated | | fragile | |
| | from a flexible | | Requires | |
| | polymer, e.g. | | mechanical parts | |
| | rubber or synthetic | | Blade can | |
| | elastomer. | | wear out in high | |
| | | | volume print | |
| | | | systems | |
| Separate | A separate heater | Can be | Fabrication | Can be used |
| ink | is provided at the | effective where | complexity | with many IJ |
| boiling | nozzle although | other nozzle | | series ink jets |
| heater | the normal drop e- | clearing methods | | |
| | ection mechanism | cannot be used | | |
| | does not require it. | Can be | | |
| | The heaters do not | implemented at | | |
| | require individual | no additional | | |
| | drive circuits, as | cost in some ink | | |
| | many nozzles can | jet | | |
| | be cleared | configurations | | |
| | simultaneously, | | | |
| | and no imaging is | | | |
| | required. | | | |

NOZZLE PLATE CONSTRUCTION

| | Description | Advantages | Disadvantages | Examples |
|---|---|---|---|---|
| Electro- | A nozzle plate is | Fabrication | High | Hewlett |
| formed | separately | simplicity | temperatures and | Packard Thermal |
| nickel | fabricated from | | pressures are | Ink jet |
| | electroformed | | required to bond | |
| | nickel, and bonded | | nozzle plate | |
| | to the print head | | Minimum | |
| | chip. | | thickness | |
| | | | constraints | |
| | | | Differential | |
| | | | thermal | |
| | | | expansion | |
| Laser | Individual nozzle | No masks | Each hole | Canon |
| ablated or | holes are ablated | required | must be | Bubblejet |
| drilled | by an intense UV | Can be quite | individually | 1988 Sercel et |
| polymer | laser in a nozzle | fast | formed | al., SPIE, Vol. |
| | plate, which is | Some control | Special | 998 Excimer |
| | typically a | over nozzle | equipment | Beam |
| | polymer such as | profile is | required | Applications, pp. |
| | polyimide or | possible | Slow where | 76-83 |
| | polysulphone | Equipment | there are many | 1993 |
| | | required is | thousands of | Watanabe et al., |
| | | relatively low | nozzles per print | U.S. Pat. No. 5,208,604 |
| | | cost | head | |
| | | | May produce | |
| | | | thin burrs at exit | |
| | | | holes | |
| Silicon | A separate nozzle | High accuracy | Two part | K. Bean, |
| micro- | plate is | is attainable | construction | IEEE |
| machined | micromachined | | High cost | Transactions on |
| | from single crystal | | Requires | Electron |
| | silicon, and | | precision | Devices, Vol. |
| | bonded to the print | | alignment | ED-25, No. 10, |
| | head wafer. | | Nozzles may | 1978, pp 1185-1195 |
| | | | be clogged by | Xerox 1990 |
| | | | adhesive | Hawkins et al., |
| | | | | U.S. Pat. No. 4,899,181 |
| Glass | Fine glass | No expensive | Very small | 1970 Zoltan |
| capillaries | capillaries are | equipment | nozzle sizes are | U.S. Pat. No. 3,683,212 |
| | drawn from glass | required | difficult to form | |
| | tubing. This | Simple to | Not suited for | |
| | method has been | make single | mass production | |
| | used for making | nozzles | | |
| | individual nozzles, | | | |
| | but is difficult to | | | |
| | use for bulk | | | |
| | manufacturing of | | | |
| | print heads with | | | |
| | thousands of | | | |
| | nozzles. | | | |
| Monolithic, | The nozzle plate is | High accuracy | Requires | Silverbrook, |
| surface | deposited as a | (<1 μm) | sacrificial layer | EP 0771 658 A2 |
| micro- | layer using | Monolithic | under the nozzle | and related |
| machined | standard VLSI | Low cost | plate to form the | patent |
| using | deposition | Existing | nozzle chamber | applications |
| VLSI | techniques. | processes can be | Surface may | IJ01, IJ02, |
| litho- | Nozzles are etched | used | be fragile to the | IJ04, IJ11, IJ12, |
| graphic | in the nozzle plate | | touch | IJ17, IJ18, IJ20, |
| processes | using VLSI | | | IJ22, IJ24, IJ27, |
| | lithography and | | | IJ28, IJ29, IJ30, |
| | etching. | | | IJ31, IJ32, IJ33, |
| | | | | IJ34, IJ36, IJ37, |
| | | | | IJ38, IJ39, IJ40, |
| | | | | IJ41, IJ42, IJ43, |
| | | | | IJ44 |
| Monolithic, | The nozzle plate is | High accuracy | Requires long | IJ03, IJ05, |
| etched | a buried etch stop | (<1 μm) | etch times | IJ06, IJ07, IJ08, |
| through | in the wafer. | Monolithic | Requires a | IJ09, IJ10, IJ13, |
| substrate | Nozzle chambers | Low cost | support wafer | IJ14, IJ15, IJ16, |
| | are etched in the | No differential | | IJ19, IJ21, IJ23, |
| | front of the wafer, | expansion | | IJ25, IJ26 |
| | and the wafer is | | | |
| | thinned from the | | | |
| | back side. Nozzles | | | |
| | are then etched in | | | |
| | the etch stop layer. | | | |
| No nozzle | Various methods | No nozzles to | Difficult to | Ricoh 1995 |
| plate | have been tried to | become clogged | control drop | Sekiya et al U.S. Pat. No. |
| | eliminate the | | position | 5,412,413 |
| | nozzles entirely, to | | accurately | 1993 |
| | prevent nozzle | | Crosstalk | Hadimioglu et al |
| | clogging. These | | problems | EUP 550,192 |
| | include thermal | | | 1993 Elrod et |
| | bubble | | | al EUP 572,220 |
| | mechanisms and | | | |
| | acoustic lens | | | |
| | mechanisms | | | |
| Trough | Each drop ejector | Reduced | Drop firing | IJ35 |
| | has a trough | manufacturing | direction is | |
| | through which a | complexity | sensitive to | |
| | paddle moves. | Monolithic | wicking. | |
| | There is no nozzle | | | |
| | plate. | | | |
| Nozzle slit | The elimination of | No nozzles to | Difficult to | 1989 Saito et |
| instead of | nozzle holes and | become clogged | control drop | al U.S. Pat. No. |
| individual | replacement by a | | position | 4,799,068 |
| nozzles | slit encompassing | | accurately | |
| | many actuator | | Crosstalk | |
| | positions reduces | | problems | |
| | nozzle clogging, | | | |
| | but increases | | | |
| | crosstalk due to | | | |
| | ink surface waves | | | |

DROP EJECTION DIRECTION

| | Description | Advantages | Disadvantages | Examples |
|---|---|---|---|---|
| Edge | Ink flow is along | Simple | Nozzles | Canon |
| (‘edge | the surface of the | construction | limited to edge | Bubblejet 1979 |
| shooter’) | chip, and ink drops | No silicon | High | Endo et al GB |
| | are ejected from | etching required | resolution is | patent 2,007,162 |
| | the chip edge. | Good heat | difficult | Xerox heater- |
| | | sinking via | Fast color | in-pit 1990 |
| | | substrate | printing requires | Hawkins et al |
| | | Mechanically | one print head | U.S. Pat. No. 4,899,181 |
| | | strong | per color | Tone-jet |
| | | Ease of chip | | |
| | | handing | | |
| Surface | Ink flow is along | No bulk | Maximum ink | Hewlett- |
| (‘roof | the surface of the | silicon etching | flow is severely | Packard TIJ |
| shooter’) | chip, and ink drops | required | restricted | 1982 Vaught et |
| | are ejected from | Silicon can | | al U.S. Pat. No. |
| | the chip surface, | make an | | 4,490,728 |
| | normal to the | effective heat | | IJ02, IJ11, |
| | plane of the chip. | sink | | IJ12, IJ20, IJ22 |
| | | Mechanical | | |
| | | strength | | |
| Through | Ink flow is through | High ink flow | Requires bulk | Silverbrook, |
| chip, | the chip, and ink | Suitable for | silicon etching | EP 0771 658 A2 |
| forward | drops are ejected | pagewidth print | | and related |
| (‘up | from the front | heads | | patent |
| shooter’) | surface of the chip. | High nozzle | | applications |
| | | packing density | | IJ04, IJ17, |
| | | therefore low | | IJ18, IJ24, IJ27-IJ45 |
| | | manufacturing | | |
| | | cost | | |
| Through | Ink flow is through | High ink flow | Requires | IJ01, IJ03, |
| chip, | the chip, and ink | Suitable for | wafer thinning | IJ05, IJ06, IJ07, |
| reverse | drops are ejected | pagewidth print | Requires | IJ08, IJ09, IJ10, |
| (‘down | from the rear | heads | special handling | IJ13, IJ14, IJ15, |
| shooter’) | surface of the chip. | High nozzle | during | IJ16, IJ19, IJ21, |
| | | packing density | manufacture | IJ23, IJ25, IJ26 |
| | | therefore low | | |
| | | manufacturing | | |
| | | cost | | |
| Through | Ink flow is through | Suitable for | Pagewidth | Epson Stylus |
| actuator | the actuator, which | piezoelectric | print heads | Tektronix hot |
| | is not fabricated as | print heads | require several | melt |
| | part of the same | | thousand | piezoelectric ink |
| | substrate as the | | connections to | jets |
| | drive transistors. | | drive circuits | |
| | | | Cannot be | |
| | | | manufactured in | |
| | | | standard CMOS | |
| | | | fabs | |
| | | | Complex | |
| | | | assembly | |
| | | | required | |

INK TYPE

| | Description | Advantages | Disadvantages | Examples |
|---|---|---|---|---|
| Aqueous, | Water based ink | Environmentally | Slow drying | Most existing |
| dye | which typically | friendly | Corrosive | ink jets |
| | contains: water, | No odor | Bleeds on | All IJ series |
| | dye, surfactant, | | paper | ink jets |
| | humectant, and | | May | Silverbrook, |
| | biocide. | | strikethrough | EP 0771 658 A2 |
| | Modern ink dyes | | Cockles paper | and related |
| | have high water- | | | patent |
| | fastness, light | | | applications |
| | fastness | | | |
| Aqueous, | Water based ink | Environmentally | Slow drying | IJ02, IJ04, |
| pigment | which typically | friendly | Corrosive | IJ21, IJ26, IJ27, |
| | contains: water, | No odor | Pigment may | IJ30 |
| | pigment, | Reduced bleed | clog nozzles | Silverbrook, |
| | surfactant, | Reduced | Pigment may | EP 0771 658 A2 |
| | humectant, and | wicking | clog actuator | and related |
| | biocide. | Reduced | mechanisms | patent |
| | Pigments have an | strikethrough | Cockles paper | applications |
| | advantage in | | | Piezoelectric |
| | reduced bleed, | | | ink-jets |
| | wicking and | | | Thermal ink |
| | strikethrough. | | | jets (with |
| | | | | significant |
| | | | | restrictions) |
| Methyl | MEK is a highly | Very fast | Odorous | All IJ series |
| Ethyl | volatile solvent | drying | Flammable | ink jets |
| Ketone | used for industrial | Prints on | | |
| (MEK) | printing on | various | | |
| | difficult surfaces | substrates such | | |
| | such as aluminum | as metals and | | |
| | cans. | plastics | | |
| Alcohol | Alcohol based inks | Fast drying | Slight odor | All IJ series |
| (ethanol, | can be used where | Operates at | Flammable | ink jets |
| 2-butanol, | the printer must | sub-freezing | | |
| and | operate at | temperatures | | |
| others) | temperatures | Reduced | | |
| | below the freezing | paper cockle | | |
| | point of water. An | Low cost | | |
| | example of this is | | | |
| | in-camera | | | |
| | consumer | | | |
| | photographic | | | |
| | printing. | | | |
| Phase | The ink is solid at | No drying | High viscosity | Tektronix hot |
| change | room temperature, | time-ink | Printed ink | melt |
| (hot melt) | and is melted in | instantly freezes | typically has a | piezoelectric ink |
| | the print head | on the print | ‘waxy’ feel | jets |
| | before jetting. Hot | medium | Printed pages | 1989 Nowak |
| | melt inks are | Almost any | may ‘block’ | U.S. Pat. No. 4,820,346 |
| | usually wax based, | print medium | Ink | All IJ series |
| | with a melting | can be used | temperature may | ink jets |
| | point around 80° C.. | No paper | be above the | |
| | After jetting | cockle occurs | curie point of | |
| | the ink freezes | No wicking | permanent | |
| | almost instantly | occurs | magnets | |
| | upon contacting | No bleed | Ink heaters | |
| | the print medium | occurs | consume power | |
| | or a transfer roller. | No | Long warm- | |
| | | strikethrough | up time | |
| | | occurs | | |
| Oil | Oil based inks are | High | High | All IJ series |
| | extensively used in | solubility | viscosity: this is | ink jets |
| | offset printing. | medium for | a significant | |
| | They have | some dyes | limitation for use | |
| | advantages in | Does not | in ink jets, which | |
| | improved | cockle paper | usually require a | |
| | characteristics on | Does not wick | low viscosity. | |
| | paper (especially | through paper | Some short | |
| | no wicking or | | chain and multi- | |
| | cockle). Oil | | branched oils | |
| | soluble dies and | | have a | |
| | pigments are | | sufficiently low | |
| | required. | | viscosity. | |
| | | | Slow drying | |
| Micro- | A microemulsion | Stops ink | Viscosity | All IJ series |
| emulsion | is a stable, self | bleed | higher than | ink jets |
| | forming emulsion | High dye | water | |
| | of oil, water, and | solubility | Cost is | |
| | surfactant. The | Water, oil, | slightly higher | |
| | characteristic drop | and amphiphilic | than water based | |
| | size is less than | soluble dies can | ink | |
| | 100 nm, and is | be used | High | |
| | determined by the | Can stabilize | surfactant | |
| | preferred curvature | pigment | concentration | |
| | of the surfactant. | suspensions | required (around | |
| | | | 5%) | |

We claim:

1. A printhead for an inkjet printer, the printhead comprising
a wafer that defines a plurality of nozzle chambers and ink supply channels in fluid communication with the nozzle chambers to supply the nozzle chambers with ink;
an ink ejection port associated with each nozzle chamber; and
a series of actuators associated with each nozzle chamber and radially positioned with respect to the nozzle chamber, the actuators being operable so that, when activated, they are displaced into the nozzle chamber to generate an ink meniscus at the ink ejection port and, when deactivated, return to an original position resulting in the necking and breaking of the ink meniscus to eject an ink drop.

2. A printhead as claimed in claim 1, in which the nozzle chambers and the ink supply channels are the result of an etching process carried out on the wafer.

3. A printhead as claimed in claim 1, in which each actuator comprises an electrically conductive heater element in a layer of a plastics material, the heater element being positioned in the plastics material to cause uneven heating and resulting uneven expansion so that the actuators bend into the nozzle chamber.

4. A printhead as claimed in claim 3, in which each heater element is serpentine to accommodate expansion of the actuators.

5. A printhead as claimed in claim 1, in which the wafer incorporates a CMOS layer that includes power and drive circuits for the actuators.

6. A printhead as claimed in claim 1, in which each actuator includes a polytetrafluoroethylene (PTFE) layer, and an internal serpentine copper core which is heated when carrying current to bend the actuators.

7. A printhead as claimed in claim 1, wherein bridges extend radially from a rim defining the ink ejection ports and between adjacent actuators.
